(19) United States
(12) Patent Application Publication
(10) Pub. No.: US 2024/0187085 A1
(43) Pub. Date: Jun. 6, 2024

(54) REMOTE BEAM MANAGEMENT FOR NETWORK-CONTROLLED REPEATERS

(71) Applicant: Fraunhofer-Gesellschaft zur Foerderung der angewandten Forschung e.V., Munich (DE)

(72) Inventors: Jasmina MCMENAMY, Berlin (DE); Paul Simon Holt LEATHER, Berlin-Schlachtensee (DE); Thomas HAUSTEIN, Berlin (DE); Lars THIELE, Berlin (DE)

(21) Appl. No.: 18/525,659

(22) Filed: Nov. 30, 2023

Related U.S. Application Data
(63) Continuation of application No. PCT/EP2022/065142, filed on Jun. 2, 2022.

(30) Foreign Application Priority Data
Jun. 2, 2021 (EP) 21177512.7
Jun. 24, 2021 (EP) 21181577.4

(51) Int. Cl. H04B 7/155

(52) U.S. Cl. CPC H04B 7/15507

(57) ABSTRACT

An apparatus configured for communicating in a wireless communication network is configured for obtaining, based on a reception of a signal, information about an on/off mode and/or obtaining, based on a reception of a signal, information about a communication mode. The apparatus is configured for operating according to the obtained information to amplify and forward a received signal to repeat the received signal.

### CROSS-REFERENCE TO RELATED APPLICATIONS

This application is a continuation of copending International Application No. PCT/EP2022/065142, filed Jun. 2, 2022, which is incorporated herein by reference, and additionally claims priority from European Application No. 21177512.7, filed Jun. 2, 2021, and from European Application No. 21181577.4, filed Jun. 26, 2021, which are both also incorporated herein by reference in their entirety.

### TECHNICAL FIELD

The present invention relates to remote beam management for network-controlled repeaters, NCR, that are considered as reduced capability (RedCap) Integrated Access and Backhaul (IAB) nodes. The present invention in particular relates to an apparatus such as a user equipment, an apparatus such as a base station and an apparatus such as a repeater that may, alone or in combination, operate in a wireless communication network. The present invention relates to the use and impact of repeaters in wireless communication scenarios.

### BACKGROUND OF THE INVENTION

In cellular wireless networks, coverage is often location dependent. This causes a reduction in the availability of wireless connectivity and/or throughput in certain areas. Even with a well-planned macro base station deployment, such problems can still occur, especially for outdoor to indoor scenarios and in frequency range two (FR2), which uses millimetre-wave spectrum and where building shadowing has significantly stronger impact. Although the standardization of layer two (L2) relays, namely integrated access and backhaul (IAB) nodes, is underway, mobile network operators are seeking simpler solutions to extend coverage and increase capacity.

Hence, besides deploying more macro cells and/or small cells or IAB nodes, wireless repeaters are proven to extend wireless coverage into the formerly poor served spots or areal locations.

There are, however, significant challenges associated with the repeaters in mmWave spectrum, as the communication there relies on highly directional transmission, which requires accurate and updated information on channel state. In that respect, a number of questions arises, as outlined in [RP-202748]

How is the beamforming managed for the link between the gNB and the repeater?

How is the beamforming managed for the link between the repeater and the UE?

Specifically, what are the implications for the UE beam management considering that the UE-repeater beam management will be performed from the gNB?

How is transmitter power managed at the repeater? Power control for the repeater-gNB link is essential for co-existence.

How is transmitter power managed at the UE? Namely, the SNR the UE observes and reports is the SNR from the repeater, but the gNB will manage the power.

What is the impact on TDD synchronicity? The gNB-repeater control interface—there will be timing aspects to this since the repeater needs to be informed of how to set up PDSCH beams, CSI beams etc. towards the UE in advance of data being sent What are the implications on co-existence with neighbour operators?

Furthermore, in [R4-2101156], the issues related to the Initial Access, when Timing Advance is determined are raised; namely, determining the Timing Advance for the repeater and how the repeater determines the timing for reception. FIG. 1.

FIG. 1 shows a schematic block diagram illustrating the issue of timing advance and uplink transmission timing according to R4-2101156. It may be seen that there is a mismatch 1002 between a time where the repeater determines its uplink timing advance on the one hand and determines its timing for reception on the other hand.

The advantages of coverage extensions by repeaters are manyfold and include the following:
the repeater behaves transparent to the UE and the gNB (network)
cell coverage is extended by
   amplifying the received signal before retransmitting
   illuminating areas which were not well illuminated by the original base station either by blockage, extra penetration losses e.g. windows, or simply by distance (cell edge)
no complex signalling between base station/UE and repeater is needed very low additional delay is introduced by the repeater (usually in the order of frictions of the guard interval/channel impulse response)
many repeaters can be deployed in an area as long as loop amplifications are avoided

In turn, when exploiting the advantages, certain disadvantages and potential new problems have to be taken into account:
fixed coverage extension area
fixed transmit power of or fixed amplification by the repeated signal base station (network) and UEs may not be aware that a link between them is including one or more repeaters due to the transparency of the repeater
beams forming/beam steering at the repeater might not be supported
repeater is unaware about its impact on the coverage extension
coverage extension is hard to optimize without comparing measurements in the formerly poorly covered area
unknown interference situations can be created with a higher density of relays and/or uncoordinated coverage extensions by the multiple repeaters (overlapping coverage areas belonging to different cells or SSBs)

FIG. 2 shows a schematic block diagram of a time-frequency structure of a known Synchronization Signal Block (SSB). For example, a time-frequency structure of the SSB relates to an arrangement of a Primary Synchronization Signal (PSS) 1004, a Secondary Synchronization Signal (SSS) 1006, a Physical Broadcast Channel (PBCH) 1008 being arranged over different OFDM symbols and subcarriers. Such an arrangement may be fixed and may span, in total 240 subcarriers and four OFDM symbols.

Some notes about the structure of the SSB:

The SSB is comprised of the Primary Synchronization Signal (PSS), the Physical Broadcast Channel (PBCH) and the Secondary Synchronization Signal (SSS). As shown in the figure FIG. 2, these are arranged in a certain sequence of consecutive OFDM symbols.

Each SSB occupies 4 OFDM symbols in the time domain and is spread over 240 subcarriers (20 RBs) in the frequency domain.

The PSS occupies the first OFDM symbol and spans 127 subcarriers.

The SSS is located in the third OFDM symbol and spans 127 subcarriers. There are 8 un-used subcarriers below the SSS and 9 un-used subcarriers above the SSS.

The PBCH occupies two full OFDM symbols (the second and fourth), each spanning 240 subcarriers. In the third OFDM symbol, the PBCH spans 48 subcarriers below and above the SSS. This results in PBCH occupying (240+48+48+240) or a total of 576 subcarriers across three OFDM symbols.

The PBCH DM-RS occupies 144 REs which is one-fourth of total REs and remaining for PBCH payload (576−144=432 REs).

An SSB is transmitted with a periodicity of 5 ms, 10 ms, 20 ms, 40 ms, 80 ms, or 160 ms.
Longer SSB periodicities enhance network's energy performance.
Shorter SSB periodicities allow faster cell search for UEs.
A UE can assume a default periodicity of 20 ms during initial cell search or idle mode mobility.

SS Burst Sets

To enable beam-sweeping for PSS/SSS and PBCH, SS burst sets are defined. An SS burst set is comprised of a set of SSBs, where each SSB can be potentially transmitted on a different beam.

SS burst set consists of one or more SSBs.

SSBs in the SS burst set are transmitted in time-division multiplexing fashion.

An SS burst set is always confined to a 5 ms window and is either located in first-half or in the second-half of a 10 ms radio frame.

The network sets the SSB periodicity via RRC parameter ssb-PeriodicityServingCell which can take values in the range {5 ms, 10 ms, 20 ms, 40 ms, 80 ms, 160 ms}.

The maximum number of candidate SSBs (Lₘₐₓ) within an SS burst set depends upon the carrier frequency/band as follows: f_{c}≤3 GHz→Lₘₐₓ=4; 3 GHz≤f_{c}<=6 GHz→Lₘₐₓ=8; and f_{c}>6 GHz→Lₘₐₓ=64.

Within a 5 ms half frame, the starting OFDM symbol index for a candidate SSB within SS burst set depends upon the subcarrier spacing (SCS) and the carrier frequency/band as detailed in the table shown in FIG. 3 summarised from [3GPP TS 38.213 version 16.5.0 Release 16 (April 2021), section 4.1).

SCS=30 kHz case: for paired spectrum, 3 GHz, for unpaired spectrum, 2.4 GHz is used.

Entries within curly brackets denote OFDM starting symbols for the candidate SSBs.

However, the details shown in the table of FIG. 3 may change from release to release.

NB: When the network is not using beam forming, it may transmit only one SSB and hence there can only be one SSB starting position.
As an example, the timing of candidate SSBs within the SS burst set is illustrated in the figure below for the case of SCS=15 kHz and carrier frequency between 3 GHz and 6 GHz

How the SSB is Used with Beam Indexing

As a simple example, and with reference to the table of FIG. 3, further details are explained in FIG. 4 and FIG. 5a based on Case A of the table in which Lₘₐₓ=4 and there are hence a total of four beams 1012₁ to 1012₄ to for a beam pattern 1014 having the combination of those beams 1012₁ to 1012₄.

FIG. 5a refers to the known state of the art, SoTA, case of beamforming, depicting the use of SSBs as covering wider area, and then within the SSB coverage, the beamformed CSI-RS, and finally fine-tuned even finer, narrow beams, obtained through a beam management procedure being depicted in FIG. 6a-c).

Starting from a known technology as described above, there may be a need for improvements in a wireless communication system or a network operating repeaters.

### SUMMARY

An embodiment may have an apparatus, e.g., a User Equipment, UE, configured for communicating in a wireless communication network, wherein the apparatus is a first apparatus and is configured for: determining, to obtain a determination result, information indicating that a communication to a second apparatus within the wireless communication network is based on a third apparatus repeating a signal transmitted to the first apparatus or from the first apparatus; and transmitting a signal containing information indicating the determination result; and/or adapting the communication based on the determination result.

Another embodiment may have an apparatus, e.g., a repeater, configured for communicating in a wireless communication network, wherein the apparatus is configured for receiving a wireless signal; obtaining, from the wireless communication network, control information indicating at least one of an information about an ON/OFF mode; and information about a communication mode; and operating according to the obtained control information for repeating the wireless signal.

According to another embodiment, a wireless communication network may have: at least one inventive apparatus, e.g., a User Equipment, UE, as mentioned above as a first apparatus; at least one base station as a second apparatus; and at least one inventive apparatus, e.g., a repeater, as mentioned above as a third apparatus; wherein the third apparatus is configured for amplifying and forwarding a first signal received from the first apparatus to the second apparatus to repeat the first signal and/or for amplifying and forwarding a second signal received from the second apparatus to the first apparatus to repeat the second signal.

Prior recognition of the present invention is that a repeater of which operation is transparent at least for the UE making a benefit from the repeater allows to minimize the impact to the UE.

According to an embodiment, an apparatus such as a UE, is configured for communicating in a wireless communication network. The apparatus is a first apparatus and configured for determining information indicating that a communication to a second apparatus within the wireless communication network is based on a third apparatus repeating a signal transmitted to the first apparatus or from the first apparatus to obtain a determination result. The apparatus is configured for transmitting a signal to the wireless communication network containing information indicating the determination result. Alternatively or in addition, the apparatus is configured for adapting the communication based on the determination result. That is, the apparatus may communicate in awareness of making benefit from the repeater.

According to an embodiment, an apparatus such as a base station is configured for communicating in a wireless communication network. The apparatus is a first apparatus and configured for determining that communication within the wireless communication network and with a second apparatus comprises repeating of a signal via a third apparatus to obtain a determination result. The apparatus is configured for adapting the communication in the wireless communication network based on the determination result and/or for transmitting a signal to the second apparatus using a channel inside or outside the wireless communication network, the signal indicating instructions requesting the second apparatus to perform measurements in the wireless communication network to obtain a measurement result, the measurement result indicating whether the communication to the second apparatus comprises repeating of a signal by a third apparatus. This allows the apparatus to obtain information whether its communication is repeated to allow for adaptation of the communication.

According to an embodiment, an apparatus such as a repeater is configured for communicating in a wireless communication network. The apparatus is configured for receiving a wireless signal; obtaining, from the wireless communication network, control information indicating at least one of an information about an ON/OFF mode; and information about a communication mode; and operating according to the obtained control information for repeating the wireless signal.

### BRIEF DESCRIPTION OF THE DRAWINGS

Embodiments of the present invention are described in further detail with reference to the accompanying drawings in which:

FIG. 1 shows a schematic block diagram illustrating the issue of known timing advance and uplink transmission timing in the repeater-assisted communication channel;

FIG. 2 shows a schematic block diagram of a time-frequency structure of a known Synchronization Signal Block (SSB);

FIG. 3 shows an example table in connection with SS burst sets taken form 3GPP TS 38.213 section 4.1;

FIGS. 4-5a illustrate schematic details with regard to the table of FIG. 3 and how it may relate to the repeater-assisted communication;

FIG. 5b shows a schematic illustration of a behaviour of a repeater according to an embodiment and in an illustration to be compared with FIG. 5a;

FIGS. 6a-6c show a schematic illustration of a known beam management procedure;

FIG. 7 shows a schematic block diagram of a known use of spatial filters for beam forming;

FIG. 8 shows schematic illustration of a known Type 2 port selection that uses beam formed CSI-RS;

FIG. 9 illustrates the difference between a known Type 1 and a known Type 2 codebook feedback;

FIG. 10 shows a schematic table containing details about a PMI reporting;

FIG. 11 shows a schematic block diagram to illustrate an example of a resulting TDD pattern within a frame, configured by RRC using cell-specific and user-specific configuration options;

FIGS. 12-13 show tables containing different known DCI formats;

FIG. 14 shows a schematic block diagram of an apparatus according to an embodiment that may be referred to as a smart repeater of Type 1;

FIG. 15 shows a schematic block diagram of an apparatus according to an embodiment that may be referred to as a smart repeater of Type 2A;

FIG. 16 shows a schematic block diagram of an apparatus according to an embodiment that may be referred to as a smart repeater of Type 2B;

FIGS. 17a-c show schematic block diagrams of scenarios in accordance with different implementations of embodied repeaters;

FIG. 18 shows a schematic block diagram of a wireless communication network according to an embodiment;

FIG. 19 shows a schematic illustration relating to a method for exploitation of existing beam management and CSI reporting schemes in embodiments described herein;

FIGS. 20a-b show schematic block diagrams of a behaviour of a repeater according to an embodiment;

FIG. 21 shows a schematic block diagram illustrating a scenario according to an embodiment according to which a repeater is configured for simultaneously or sequentially connect to more than one base station;

FIG. 22 shows a schematic block diagram of a scenario according to an embodiment in which a repeater maintains more than one link;

FIG. 23 shows a schematic illustration of a scenario according to an embodiment having a smart repeater, wherein the signal processing are processed by a digital signal processor;

FIG. 24 shows a schematic illustration of a scenario according to an embodiment in which a multi-repeater reception scenario at the UE is implemented;

FIG. 25 shows a schematic block diagram of a scenario in accordance with embodiments, that address inter-channel-interference;

FIG. 26 shows a schematic block diagram of a wireless scenario according to an embodiment having at least two base stations operated by same or different network operators;

FIG. 27 shows a schematic block diagram of a scenario according to an embodiment to illustrate a keyhole effect when going outdoor-to-indoor of a building with a single antenna repeater;

FIG. 28a shows a schematic block diagram of a SSB transmission in a scenario with SR according to an embodiment;

FIG. 28b shows a schematic block diagram of a scenario where, when compared to the embodiment of FIG. 28a, only a single SSB is received by the SR, the SR itself transmitting a higher number of SSBs based thereon, according to an embodiment;

FIG. 29 shows a simulation result indicating that a physical downlink control channel, PDCCH, may be always transmitted within a CORESET according to an embodiment;

FIG. 30 shows a schematic representation of a possible PDCCH mapping to CORESET according to an embodiment;

FIG. 31 shows a schematic representation of PDCCH parameters according to an embodiment;

FIG. 32 shows a schematic block diagram illustrating an overview of PDCCH processing in NR;

FIG. 33 shows a schematic representation of an example showing an SS burst set comprised of eight SS blocks;

FIG. 34 shows a schematic representation of how the eight SSBs are mapped to eight beams; and

FIG. 35 shows a schematic representation of an SSB Burst for subcarrier spacing, SCS, of 15 kHz.

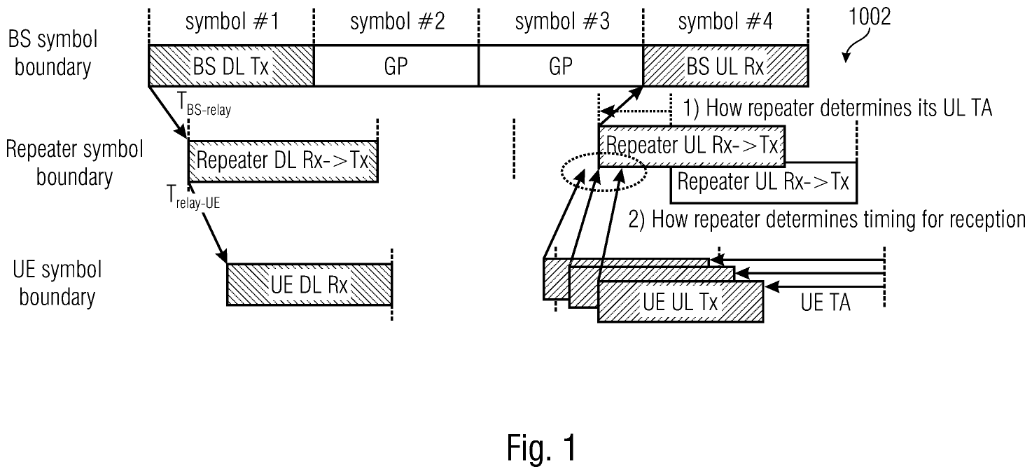

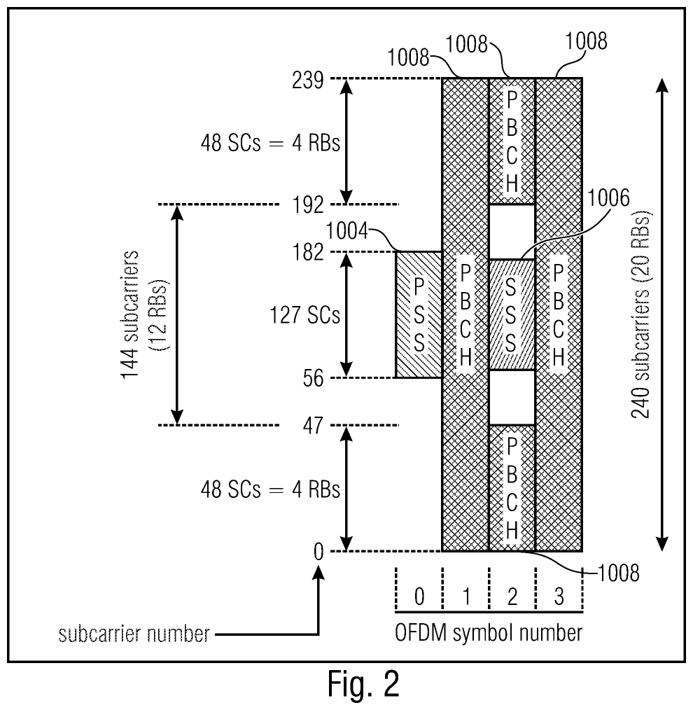

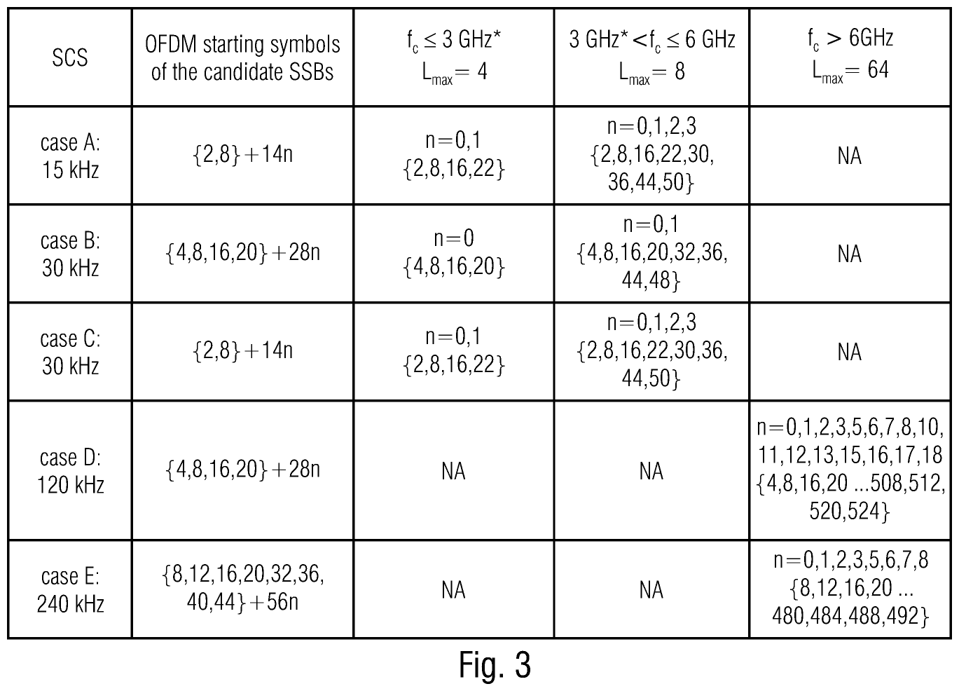

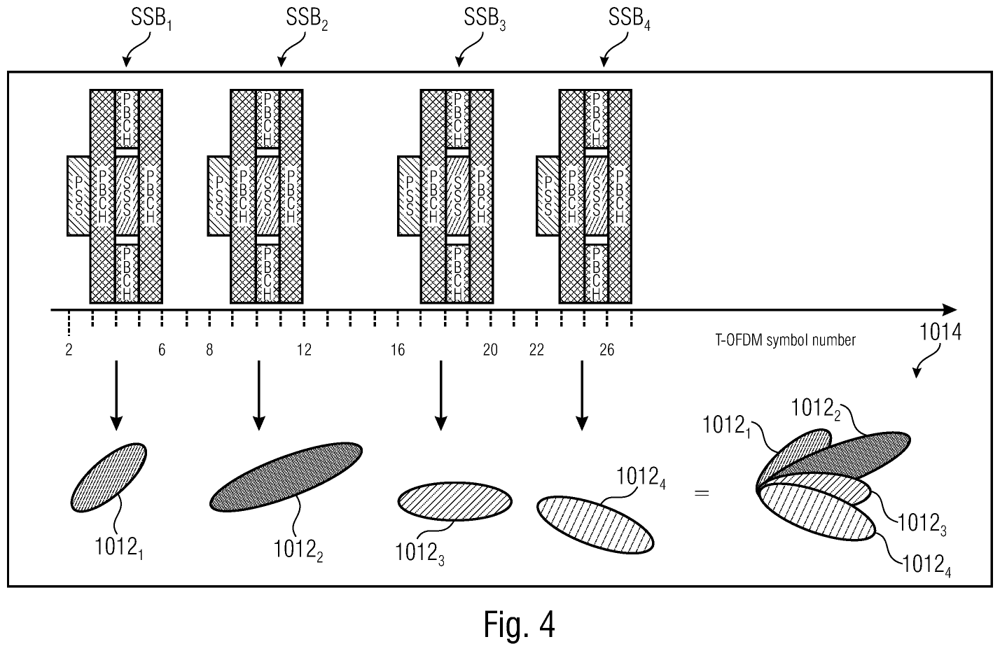

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

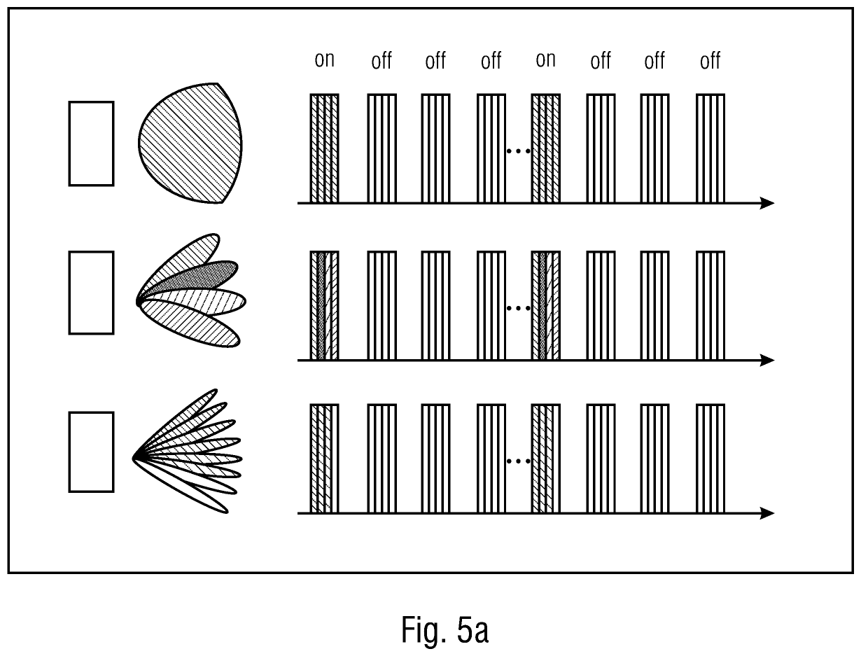

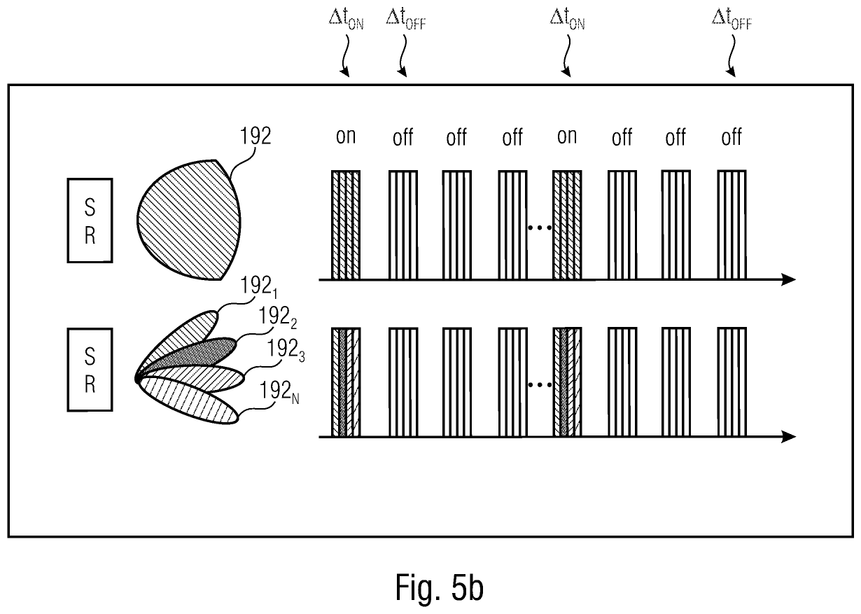

FIG. 5b shows a schematic illustration of a behaviour of a SR according to embodiments and in an illustration to be compared with FIG. 5a, the repeater may be OFF during specified time units—e.g. slots, symbols and the like. The figure, hence, shows various beamforming options from a fixed/static beam illuminating a constant spatial area with the access link. The second row shows an example of an periodically switched beam pattern, allowing the SR to illuminate/cover various spatial areas/direction with more power at different times, wherein such areas may occupy several users. The third example depicts refined beamforming within the switched beams allowing a separation of users served in the same time slot/period by the exploitation of multiple refined beams towards the users, exploiting spatially multiplexing and/or diversity. It has to be noted, that all of these beamforming examples may entail a tight coordination between the backhaul link and the associated access links in a way that all used reference signals (RS) and channels are mapped from the backhaul link to the forwarded access link in downlink and/or uplink. Since some signals/messages are mapped onto the channels/beams in a temporal manner, embodiments provide a relate to synchronizing and coordinating this temporal behaviour when mapping/forwarding backhaul beams to access beams. The time relationship is depicted by adding colours to the beams, illustrating examples of time to spatial beam relationships.

Based on an ON/OFF signalling or other mechanisms, a SR according to an embodiment, e.g., of Type 1 may be, in view of transmitting a signal using a beam 192, active or ON during some time intervals Δt_{ON} and inactive or OFF during other time intervals Δt_{OFF} where possible no beam is generated at least for TX purposes in the relevant frequency range. Forming the beam may relate to form the beam 192 during the complete time interval Δt_{ON}. However, other implementations of embodiments, e.g., repeaters of Type 2A and/or 2B may allow for generating multiple beams 192₁ to 192_{N}, e.g., sequentially one after the other during a respective time interval Δt_{ON} whilst not generating a beam in OFF-intervals Δt_{OFF}.

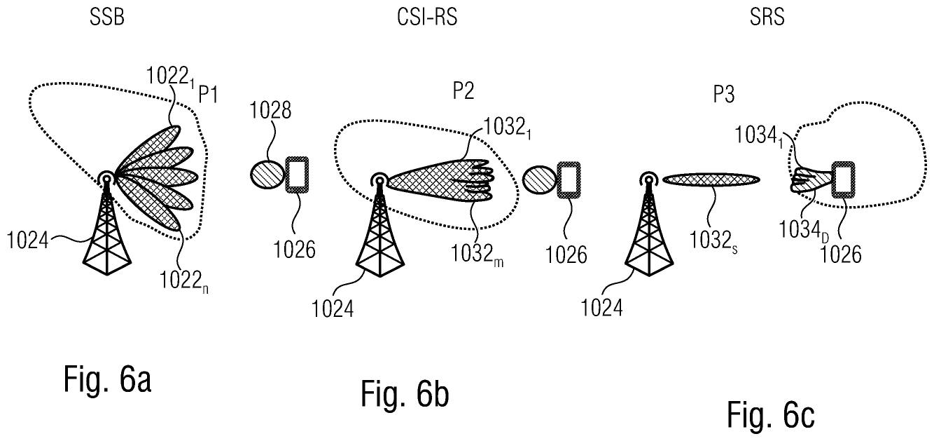

The number of N may be at least 2, e.g., 2, 3, 4, 6 or more. FIGS. 6a to 6c show a schematic illustration of a beam management procedure. During a step P1 shown in FIG. 6a, SSBs are used to obtain a number of n comparatively broad beams 1022₁ to 1022ₙ being transmitted by a base station 1024. A device 1026, e.g., a UE, may transmit a response 1028 that may allow the base station 1024 in a step P2 being shown in FIG. 6b to transmit comparatively narrow beams 1032₁ to 1032_{M} being narrower when compared to beams 1022 towards a direction of the device 1026 being determined based on the response 1028 that indicates the reception of one of the beams 1022. The base station 1024 may use CSI-RS (channel state information reference signals) to determine beam 1032ₛ from the set of beams 1032₁ to 1032ₘ as being most suitable for communicating with device 1026, device 1-26 forming one or more beams 1034₁ to 1034_{O} using sounding reference signals SRS in step P3 as shown in FIG. 6c.

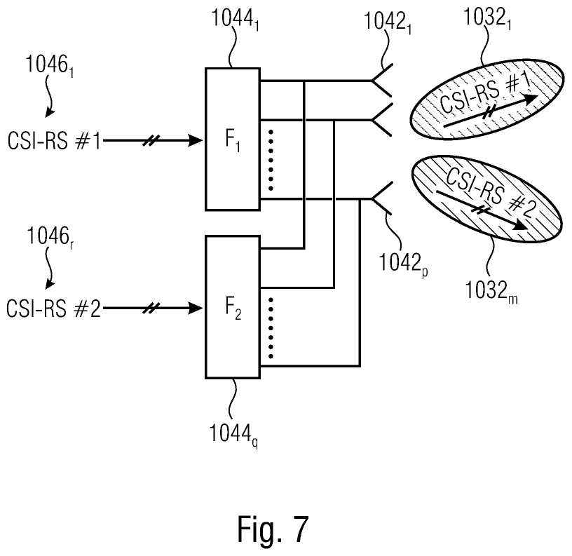

As shown in FIG. 7, beams 1032 may be generated by use of multiple antenna elements 1042₁ to 1042ₚ that are connected to spatial filters 1044₁ to 1044_{q} and that are fed with a respective CSI-RS 1046₁ to 1046ᵣ. That is, different spatial filters may be applied to different CSI-RS as known from Dahlman et al.

Overview of CSI-RS in NR

Channel State Information (CSI) is a mechanism whereby a UE measures radio channel quality and reports the result to the base station. While SSBs can be used for estimation of, for example, path loss and average channel quality, they are not suitable for more detailed channel sounding due to the limited bandwidth and low duty cycle. Hence, for beam management and mobility, the main DL reference signal is CSI-RS.

CSI Resources & Reporting

NR provides a flexible and comprehensive framework to configure CSI measurement resources and associated reporting.

The DL resources configuration, configured by RRC, defines: (i) the DL resources on which the measurements will be carried out; (ii) specific quantity or set of quantities to be reported, and (iii) how that reporting will be delivered to the base station.

Specifically, a UE is configured with a measurement setting using IE CSI-MeasConfig. This IE is used to configure CSI-RS (reference signals) belonging to the serving cell, channel state information reports to be transmitted on PUCCH on the serving cell in which the IE is included and channel state information reports on PUSCH triggered by DCI received on the serving cell in which CSI-MeasConfig is included. In summary, the measurement configuration includes N≥1 CSI reporting settings and M≥1 resource settings [Onggosanusi et al.] The IE CSI-ResourceConfig defines a group of one or more CSI resource sets. These resource sets can include the so-called Non-Zero-Power (NZP) CSI-RS sets, interference management sets, i.e. CSI-IM and/or CSI-SSB resource sets (TS 38.331). Resource sets link resources using resources IDs and set-specific parameters. For measuring channel characteristics, a resource configuration is associated with at least one NZP-CSI-RSResourceSet. Although it is named NZP_CSI-RS, it may contain configuration related to either a set of CSI-RS or a set of SS blocks.

CSI-RS resources can be periodic, aperiodic (event-triggered) and semi-persistent, which is also configured by RRC signalling. The UE is informed of aperiodic transmission instance by means of DCI while the activation/deactivation of semi-persistent resource transmission done using MAC Control Element, MAC CE.

Reporting is done according to the configuration in CSI-ReportConfig. The IE CSI-ReportConfig is used to configure a periodic or semi-persistent report sent on PUCCH on the cell in which the CSI-ReportConfig is included. It is also used to configure a semi-persistent or aperiodic report sent on PUSCH triggered by DCI received on the cell in which the CSI-ReportConfig is included.
CSI-RS is transmitted per port
up to 32 ports defined in NR
each port has a different CSI-RS sequence
to minimize pilot overhead, CSI-RS resources will be transmitted orthogonally using a combination of
   Code-domain sharing (CDM)
   Frequency-domain sharing (FDM)
   Time-domain sharing (TDM)
CSI-RS port can be filtered by the gNB using a spatial filter B at every port
the filter and the actual number of antennas are not visible to the UE
the UE just sees the number of CSI ports used by the gNB
B has a strong relation to the concept of antenna port

CSI-Acquisition and Feedback

There are two types of CSI that differ in the structure and size of the precoder codebooks, Type I CSI and Type II CSI.
Type I CSI primarily targets scenarios where a single user is scheduled within a given time/frequency resource (no MU-MIMO), potentially with transmission of a relatively large number of layers in parallel (high-order spatial multiplexing);
Type II CSI primarily targets MU-MIMO scenarios with multiple devices being scheduled simultaneously within the same time/frequency resource but with only a limited number of spatial layers (maximum of two layers) per scheduled device.

The codebooks for Type I CSI are relatively simple and primarily aim at focusing the transmitted energy at the target receiver. Interference between the potentially large number of parallel layers is assumed to be handled primarily by means of receiver processing utilizing multiple receive antennas.

The codebooks for Type II CSI are significantly more extensive, allowing for the precoding matrix indicator (PMI) to provide channel information with much higher spatial granularity.

The more extensive channel information allows the network to select a downlink, DL, precoder that not only focuses the transmitted energy at the target device but also limits the interference to other devices.

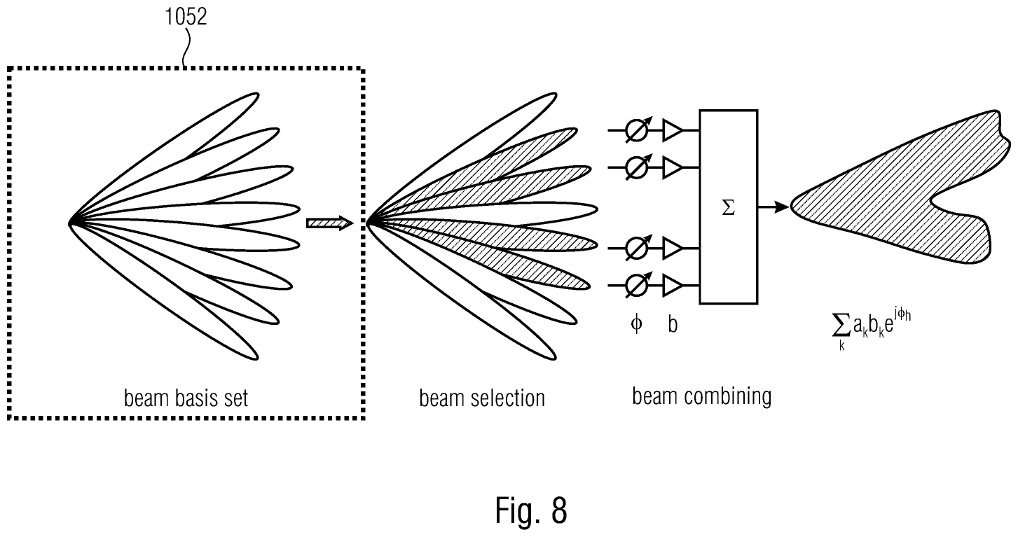

FIG. 8 shows a Type 2 port selection that uses beam formed CSI-RS, i.e., beams in box 1052 being pre-configured by the gNB and hence the UE can only select from the offered ones. In contrast, in the regular Type 2 UE has to calculate the appropriate pre-coders (DFT-weights) and then selects from these beams up to L=4 beams for reporting. According to embodiments, such a codebook is implemented in a repeater.

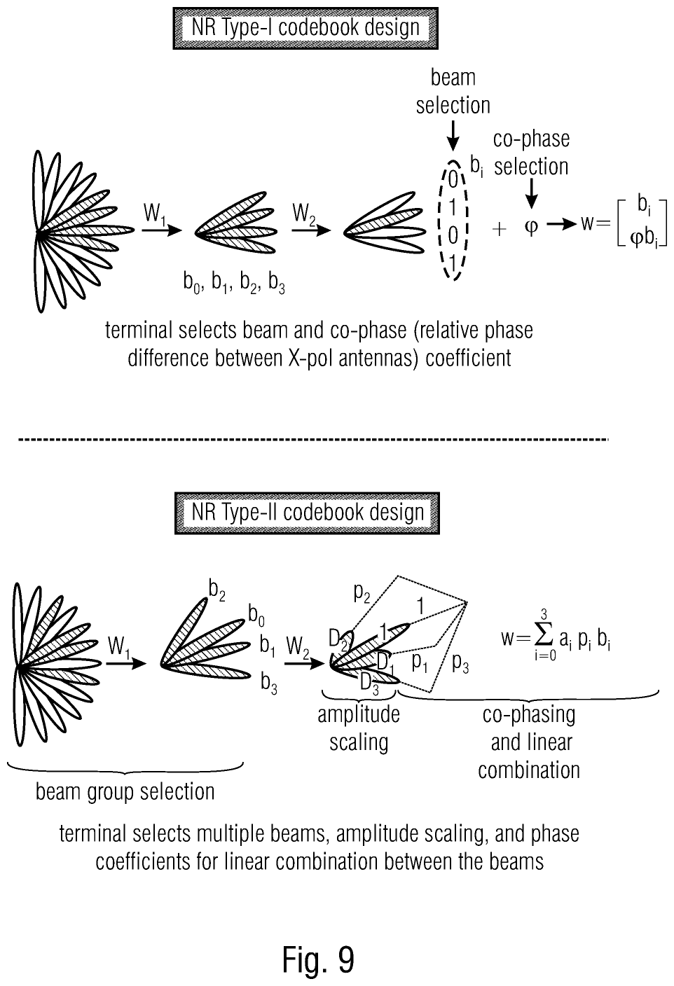

The difference between Type I/Type 1 and Type II/Type 2 codebook feedback is illustrated in FIG. 9. The point is that Type I selects only one specific beam from a group of beams, whereas Type II selects a group of beams and linearly combine all the beams within the group. According to embodiments, such a codebook of Type I and/or Type II is implemented in a repeater.

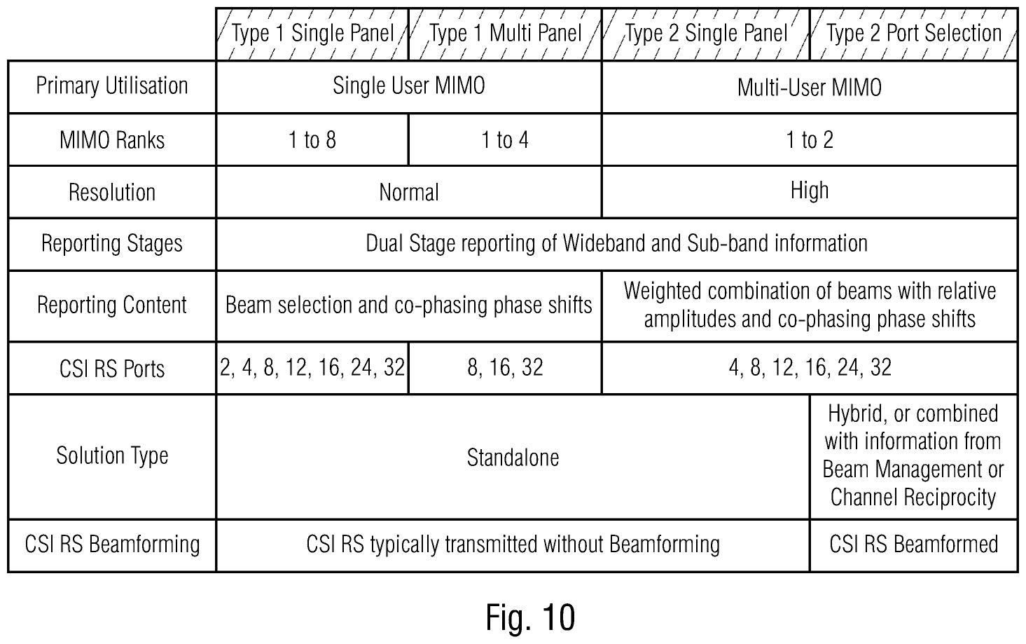

FIG. 10 shows a schematic table containing details about the PMI reporting.

There are no CRS-like signals in NR. Rather, the only “always-on” NR signal is the SS block which is transmitted over a limited bandwidth and with a much larger periodicity compared to the LTE CRS. The SS block can be used for power measurements to estimate, for example, path loss and average channel quality. However, due to the limited bandwidth and low duty cycle, the SS block is not suitable for more detailed channel sounding aimed at tracking channel properties that vary rapidly in time and/or frequency.

Instead, the concept of CSI-RS is reused in NR and further extended to, for example, provide support for beam management and mobility as a complement to SS block.

In NR, a CSI-RS is always configured on a per-device basis. The configuration on a per-device basis does not necessarily mean that a transmitted CSI-RS can only be used by a single device. The same CSI-RS can be separately configured for multiple devices, in practice implying that a single CS-RS is shared between the devices. In general, a CSI-RS can be configured for periodic, semi-persistent, or aperiodic transmission.

In the case of periodic CSI-RS transmission, a device can assume that a configured CSI-RS transmission occurs every Nth slot, where N ranges from as low as four, that is, CSI-RS transmissions every fourth slot, to as high as 640, that is, CSI-RS transmission only every 640th slot. In addition to the periodicity, the device is also configured with a specific slot offset for the CSI-RS transmission.

In the case of semi-persistent CSI-RS transmission, a certain CSI-RS periodicity and corresponding slot offset are configured in the same way as for periodic CSI-RS transmission. However, actual CSI-RS transmission can be activated/deactivated based on MAC control elements (MAC CE). Once the CSI-RS transmission has been activated, the device can assume that the CSI-RS transmission will continue according to the configured periodicity until it is explicitly deactivated. Similarly, once the CSI-RS transmission has been deactivated, the device can assume that there will be no CSI-RS transmissions according to the configuration until it is explicitly re-activated.

In the case of aperiodic CSI-RS, no periodicity is configured. Rather, a device is explicitly informed (“triggered”) about each CSI-RS transmission instant by means of signalling in the DCI.

In addition to being configured with CSI-RS, a device can be configured with one or several CSI-RS resource sets, officially referred to as NZP-CSI-RS-ResourceSets. Each such resource set includes one or several configured CSI-RS. The resource set can then be used as part of report configurations describing measurements and corresponding reporting to be done by a device. Alternatively, and despite the name, an NZP-CSI-RS-ResourceSet may include pointers to a set of SS blocks. This reflects the fact that some device measurements, especially measurements related to beam management and mobility, may be carried out on either CSI-RS or SS block.

Time-Domain Pattern Signalling to the UE NR supports the configuration of slot format in static, semi-static or fully dynamic fashion. Static and semi-static slot configuration is done via RRC while dynamic slot configuration uses PDCCH DCI.

RRC Signalling

Slot configuration via RRC comprises or consists of two parts. First part is the cell-specific information element, IE, in system information block 1, SIB1, i.e. TDD-UL-DL-ConfigurationCommon, which provides all the UEs in the cell with cell-specific DL/UL pattern, wherein TDD means time division duplex.

The second part is configured by the IE TDD-UL-DL-ConfigurationDedicated via dedicated radio resource control RRC signalling. This UE specific configuration further modifies/allocates the unallocated (flexible) slots and symbols by TDD-UL-DL-ConfigurationCommon. IE TDD-UL-DL-ConfigurationCommon, is carried in SIB1, within servingCellConfigCommon IE (Ref. TS 38.331, sec. 6.3.2, V16.4.1 (2021-04). The IE TDD-UL-DL-ConfigDedicated determines the UE-specific Uplink/Downlink TDD configuration, which can override the common configuration. This configuration further modifies/allocates the unallocated (flexible) slots and symbols. The IE TDD-UL-DL-ConfigurationDedicated is optional and if the network does not configure this IE, the UE uses TDD-UL-DL-ConfigurationCommon alone to derive the slot configuration.

The configuration in TDD-UL-DL-ConfigurationDedicated overrides only flexible symbols per slot and cannot change slots/symbols already allocated for downlink/uplink via TDD-UL-DL-ConfigurationCommon (Ref. 38.331 V16.4.1 (2021-04), sec. 6.3.2).

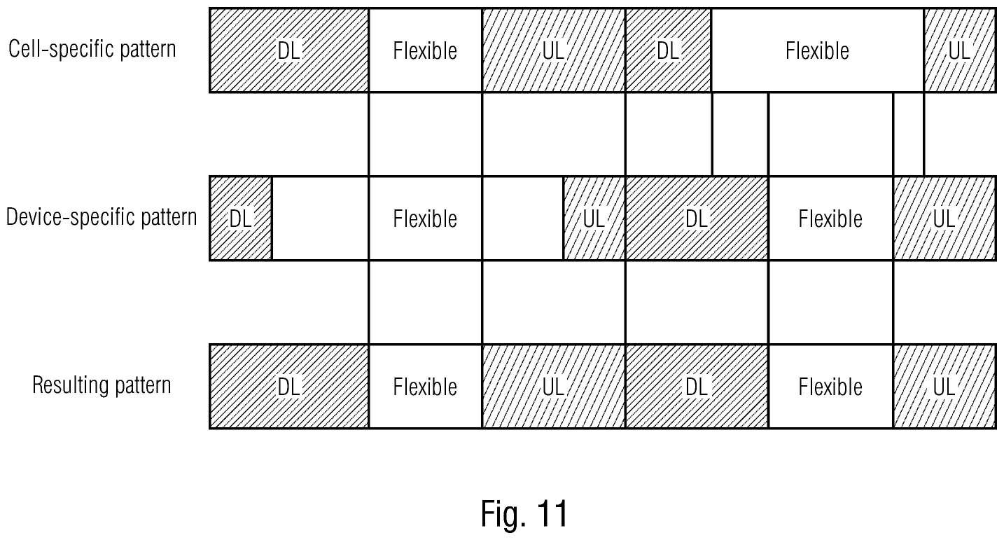

FIG. 11 shows a schematic block diagram to illustrate an example of a resulting TDD pattern within a frame, configured by RRC using cell-specific and user-specific configuration options as may be seen in Ref: https://info-nrlte.com/2020/09/28/dynamic-tdd/.

DCI Indication of Slot Format

Flexible slots can be dynamically signalled via DCI in group-common PDCCH (GCPDCCH). When the dynamic signalling is configured, a UE should monitor GC-PDCCH, which carries dynamic slot format indication (SFI). PDCCH DCI format 2_0 with CRC that is scrambled with SFI-RNTI (radio network temporary identifier) is used for this purpose. Hence, by making use of layer1 signalling, the remaining (if any) flexible symbols can dynamically be reconfigured. Multiple UEs in the group are allocated with same SFI-RNTI and hence all those UEs decode same PDCCH (DCI). Each UE extracts its own SFI based on the position of SFI within DCI (configured by RRC).

Configuration Via Scheduling

In addition to the above discussed mechanisms, when the network is already scheduling a UE with scheduling grants/assignments, the network could dynamically inform the UE about transmit/receive pattern. Namely, in a downlink frame slot, the UE assumes that downlink transmissions only occur in downlink or flexible symbols, whereas in an uplink, UL, frame slot, the UE only transmits in uplink or flexible symbols.

If the UE is not configured with SlotFormatIndicator and during the flexible symbols configured by DL-ConfigurationCommon and TDD-UL-DL-ConfigurationDedicated (if configured);
the UE receives PDSCH or CSI-RS in the set of symbols of the slot if the UE receives a corresponding indication by a DCI format 1_0, DCI format 1_1, or DCI format 0_1.
the UE transmits PUSCH, PUCCH, PRACH, or SRS in the set of symbols of the slot if the UE receives a corresponding indication by a DCI format 0_0, DCI format 0_1, DCI format 1_0, DCI format 1_1, or DCI format 2_3.

The following two sections describe aspects of DCI which are relevant to scheduling in the context of firstly LTE and secondly NR.

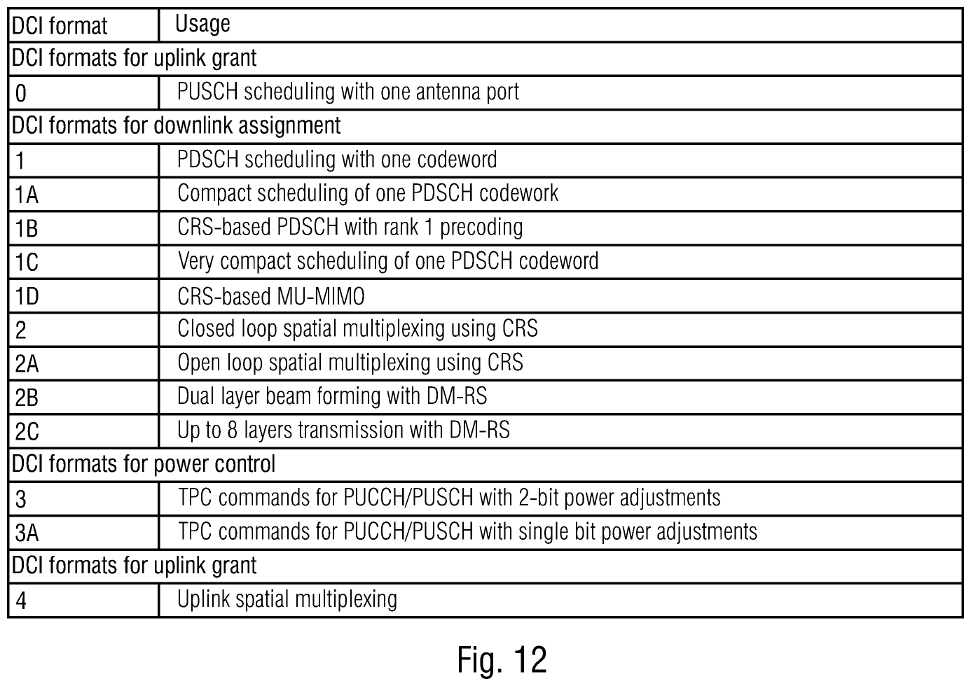

DCI in the context of LTE The PDCCH transmits downlink control information (DCI) including downlink scheduling assignments, uplink scheduling assignments (i.e., UL grant), and power control information to the UE. A number of DCI formats are defined such as format 0/1/1A/1B/1C/1D/2/2A/2B/2C/3/3A/4, which depends on downlink or uplink scheduling assignment, the carried control information (e.g., power control, MCC change), transmission scheme, and the payload size. The LTE DCI formats specified in Release-10 are summarized in the table shown in FIG. 12 taken from [Lei et al], the table also showing the use of the formats

The flexible frame structure is beneficial to adapt the service traffic in downlink and uplink. The signalling of slot formats needed for UE to obtain the frame structure includes cell-specific higher layer configuration, UE-specific higher layer configuration, UE-group DCI, and UE-specific DCI.

DCI in the Context of NR

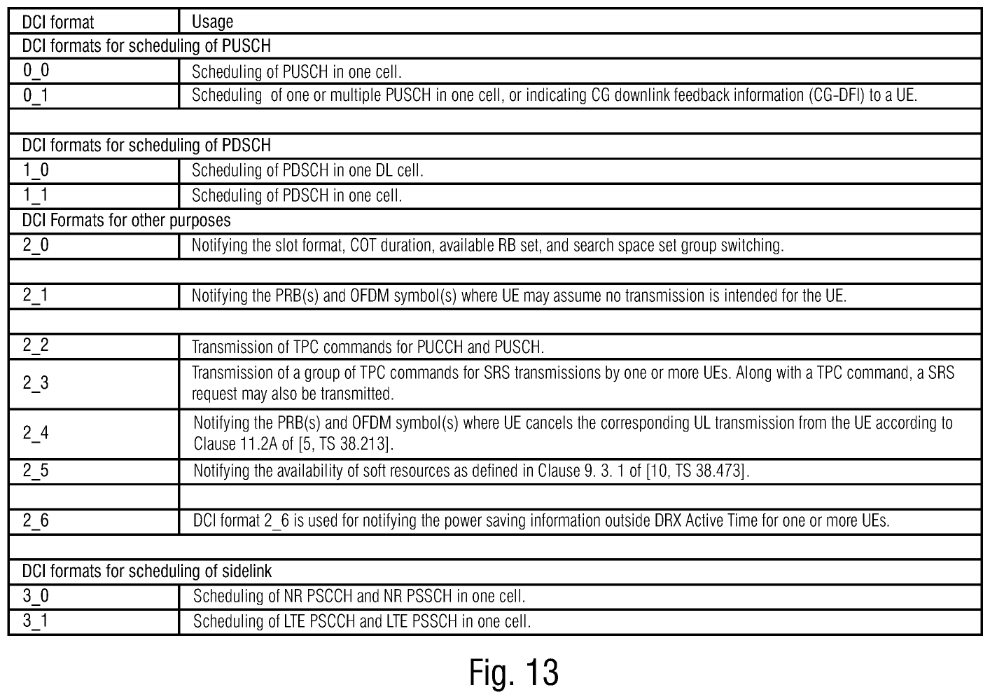

The PDCCH carriers downlink control information (DCI) for PDSCH scheduling, PUSCH scheduling, or some group control information, e.g., power control information for PUSCH/PUCCH/SRS, slot format configuration and sidelink configuration. The defined set of DCI formats (see also 3GPP TS 38.212 version 16.5.0 Release 16 (2021-04)) are shown in the table shown in FIG. 13 taken from [Lei et al], the table illustrating NR DCI formats and their usage.

Similar to LTE, to minimize the PDSCH decoding latency, the PDCCH is normally located at the beginning 1/2/3 OFDM symbols of a slot in time domain. However, PDCCH does not span the entire carrier bandwidth in the frequency domain as in LTE. The rational is that the UE channel bandwidth may be smaller than carrier bandwidth, as well as the resource granularity of the PDCCH spanning the entire carrier bandwidth is rough which could result in increasing the resource overhead especially for larger bandwidth, e.g., 100 MHz. Hence, a number of resource blocks in the frequency domain are configured by higher layer for the PDCCH. The multiplexing of the PDCCH and PDSCH in one slot is TDM-like but not pure TDM. In NR, the PDSCH resource mapping are rate matched around the control resource set(s) when the PDSCH is overlapped with the configured control resource sets. The resource unit assigned for PDCCH is known as a control resource set (CORESET). A control resource set consists of N_{RB}^{CORESET} resource blocks in the frequency domain and N_{symb}^{CORESET} symbols in the time domain, where the resource blocks are configured by a bitmap. These two parameters are configured by the higher layer parameter ControlResourceSet IE. The assigned resource blocks are in the form of a number of resource block group (RBG) consisting of six consecutive resource blocks each. Up to three control resource sets can be configured for one UE to reduce the PDCCH blocking probability.

Given the configured PDCCH resources, the PDCCH is mapped onto these resources and transmitted. A PDCCH is formed by aggregating a number of control channel elements (CCEs), which depends on the aggregation level of that particular PDCCH. The aggregation level may be 1,2,4,8, or 16. One CCE consists of six resource-element groups (REGs) where a REG equals one resource block during one OFDM symbol. There is one resource element for PDCCH DM-RS every four resource elements in one REG, and therefore the number of available resource elements of one CCE is 48. The REGs within a control resource set are numbered in increasing order in a time-first manner, starting with 0 for the first OFDM symbol and the lowest-numbered resource block in the control resource set.

It is noted that the information in the above section is only for enhancing the understanding of the background of the invention and therefore it may contain information that does not form known technology that is already known to a person of ordinary skill in the art. Some of the embodiments described herein relate to the addition of functionality to non-regenerative repeaters where the incoming wireless signal is received by a receive antenna, filtered, amplified, and forwarded and transmitted by another antenna towards a direction area, which needs coverage extension. Regenerative relays like, e.g., full decode and forward relays that are standardized in LTE-Advanced 3GPP or IAB nodes as introduced in 3GPP, see, e.g.,: Relay Technology in LTE-Advanced, NTT Docomo Technical Journal, Vol 2, No. 2 or Study on Integrated Access and Backhaul; 3GPP TR 38.874 V16.0.0 (2018-12) are outside the scope of present embodiments.

Embodiments are based on the finding that simple amplify and forward (A&F) repeaters may be enhanced by introducing ‘smartness’, allowing their effectiveness and efficiency to controllable by taking evidence (measurement) based input into account. In order to enable and design such kind of smart repeater, the smart repeater (SR) that is synonymously called network-controlled repeater, NCR, or RedCap IAB nodes has to be provided with the following functions:
control channel (CC) between the SR and the network (uni- or bi-directional)
   CC can be inband, outband, OTT, a measurement control channel, etc.
   May control: amplification, output power, band filtering, spectral, temporal and spatial receive and transmit filters/shaping, beamforming, specific other input output relationships, uni- or bi-directional validity of settings, assist in sync
feedback mechanism allowing to identify the effect of the presence of the active repeater and its configuration creating a particular coverage situation
   UE and/or network assisted end-to-end wireless link measurements with the repeater in between
   Coordination mechanism between repeater configuration/setting and measurement process
   Means to correlate specific repeater configurations and measurements/observation of the repeater effect

Feature to make the repeater identifiable to the UE and/or network when being of relevance in a wireless link between a UE and a base station.

When operating a repeater with only a single antenna, at least one side (communication link between base station and repeater and/or communication link between the repeater and the UEs) part of the concatenated channel becomes ‘squeezed’ into a MISO and/or SIMO spatial channel, therefore reducing the spatial degrees of freedom to ONE, although it operates in rich multi-path propagation environment.

Such effect is known as enforced rank deficiency or keyhole channel and has to be detected and handled accordingly.

Besides the reduced spatial rank, other mechanisms within the CSI feedback framework will not be affected, therefore these may become already existing means to identify and report keyhole channels on one or more links.

Exemplarily, the 2 MIMO feedback schemes (Type I and Type 1l) from FIG. 8 and/or FIG. 9 and the effect of the keyhole channel are briefly described in this context.

Assuming a MIMO antenna at the base station and a single antenna at least on one side of the repeater, the transmitted radio signals from the base station in the downlink will arrive at the repeater's backhaul receive antenna after via multiple multi-path components (MPCs). The effective channel between the basestation transmit antennas and the receiver antenna, therefore, becomes a MISO channel (Multiple Input Single Output) or a SISO channel (Single Input Single Output) if the basestation transmit via a single antenna only. In a SISO/MISO channel the resulting rank (spatial degrees of freedom) is ONE, which can be derived by decomposing the spatial channel into its Eigenspaces using singular value decomposition (SVD). In practice, this means that signals mapped onto different OFDM subcarriers will propagate via the same paths, and therefore experience only frequency-dependent effective signal phases when superimposing at the single receive antenna at the repeater. If multiple independent streams were transmitted from the base station, these superimpose in a similar fashion which a frequency dependent phase offset, reflecting the different location and/or radiation pattern of the second antenna and/or stream. To the best knowledge of the inventors, spatial separation of these two streams is almost infeasible, in particular when doing signal processing in the narrowband regime as is usually done in OFDM systems.

Therefore, even if the access side of the repeater (communication link between repeater and UEs) would provide multiple antennas and/or there is a rich multipath propagation environment, the resulting spatial degree of freedom will remain ONE.

In CSI feedback scheme, as described in FIG. 8, the UE receiver observes/measures the propagation channel be evaluating the phase and amplitude of reference signals (RS) embedded in the OFDM frame structure. These reference signals were beforehand mapped onto different antenna ports at the base station prior to transmission to mark specific antenna ports, transmit beams or alike. In type I CSI feedback, the UE is evaluating and selecting the best (strongest) antenna/beam and will report its index to the base station. As a consequence, the base station will use the beam/antenna with the best effective transmission channel between the base station and the UE. In our given example, this will be the beam which points best to the backhaul receive antenna of the repeater and therefore type I feedback will automatically select the best backhaul beam transparently forwarded by the repeater. It has to be noted, that this assumes a fixed receiver and transmit pattern applied at the repeater during the tape I CSI feedback procedure.

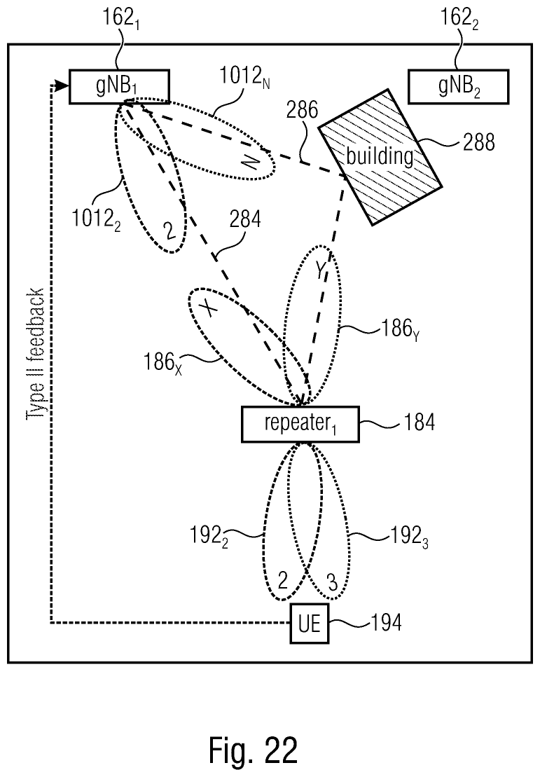

In type II feedback the UE will report on a subset of transmit beams provided by the base station and how these should be combined in phase and amplitude. When performing such procedure over the keyhole channel part of the at least two concatenated channels, the reported feedback will request a beam which is optimally pointing to the repeaters backhaul antenna. Therefore, CSI type II feedback is the perfect means to optimize the backhaul link, measured transparently through the repeater. According to an embodiment, the repeater cooperates with such a UE by exploiting multipath propagation between the repeater 184 and at least one BS and forwards multiple links to the UE 194 as shown in the scenario of FIG. 22.

Since all and each UE behind the repeater will select the same best beam (type I feedback) or report phase and amplitude combinations (type II feedback), which effectively request the same beam to be used by the base station, comparing CSI feedback from several UEs, in particular if these are non-collocated may provide an indication that these UEs are served from the base station via a repeater.

Multiple aspects are addressed by the described embodiments and by introducing SR into the network, e.g., for a use as a network controlled repeater:
Definition of Repeater architecture incl. interfaces and functionalities
For example, one of the requirements may be that the SR operation shall be transparent to UEs i.e. that there will be no UE impact, or that the introduction of SRs will have a minimum impact. The following aspects need to be studied, in particular to ensure maximum UE transparency
   Initial access (synchronization, measurement, RACH)
   Beam management (P1, P2, P3 procedures for UL and DL, repeater panel/beam selection)
   MIMO (PDSCH demodulation and CSI report when the # of antenna at the repeater is not as large as BS)
   Detecting and handling of reduced channel rank (rank deficiency, keyhole channel) if the repeater is operating on single stream only.
   UL power control
   UL timing advance
   RRM (SCell activation/deactivation, handover, . . . )
Also the functions needed for this smart repeater, e.g.,
   Minimum existing “UE” functions that are needed for the repeater in order to maintain the link to BS,
   Existing “UE” functions that are not needed for the repeater to operate (e.g. mobility?)
   New functions for BS to control the repeater.

New Radio, NR, repeaters have been discussed in 3GPP [RP-202748]. One of the main premises in the recent status report to Technical Specification Group (TSG) RAN [RP-210750] and in [RP-210818] is that it is assumed that the repeater does not perform adaptive beamforming towards the UE.

Furthermore, the previous Work Item Descriptions (WIDs) state that some side control information to enable a more intelligent amplify-and-forward operation in a system with TDD access and multi-beam operation is used.

3GPP Standardization of Repeaters for NR

[RP-210750], captures aspects on the way forward for NR Repeaters and which are considered relevant in the context of at least some of the embodiments described herein, in particular in the context of the proposed novel solution components/aspects.

Some embodiments relate to minimizing the impact to the UE, i.e., the repeater operation is implemented to be, as far as possible, transparent to the UE.

Embodiments describe a set of features and implementation options that can be used with repeaters of various levels of functionality and complexity. Components of the embodiments described herein can be combined, fully or partially, depending on the scenario or use case in which the Smart Repeater, SR, or network-controlled repeater, NCR, is used and the requirements of the operator. The invention thus concerns the selective addition of new features to simple amplify-and-forward (AF) repeater family and thus provides the means to make “simple” repeaters to operate “smart”.

Some repeaters may be introduced into existing networks in order to provide an extension or an infilling of radio coverage. Therefore, the introduction of a repeater into a network should, as far as possible, make use of the existing channels, signalling and protocol frameworks that are already used in the network and are defined in the relevant standards and specifications. This should not only help to ensure that the installation and configuration of a repeater is simple and straightforward, that existing network elements are not adversely affected by its presence and that minimum network maintenance is entailed but also offer some means of forward compatibility entailing future upgrades.

Within the presented embodiments repeaters may be categorized into two broad categories, according to the functionality and the signal processing. They may be named SR Type 1 and SR Type 2. The SR Type 1 in UL and/or DL may perform, e.g., only limited signal processing, which may include decoding the information on TDD pattern and/or dynamic slot indication. This can be signalled to the repeater using, e.g. a separate communication channel, such as out-of-band LTE or it can be signalled by the NR base station by a repeater-specific sequence (signal). In the UL, the SR Type 1 may perform conventional Amplitude and Forward (AF). Repeaters according to embodiments may operate according to a TDD scheme, according to an FDD scheme or according to a combination thereof, e.g., in full-duplex. A limited signal processing may be implemented in an FDD scheme accordingly.

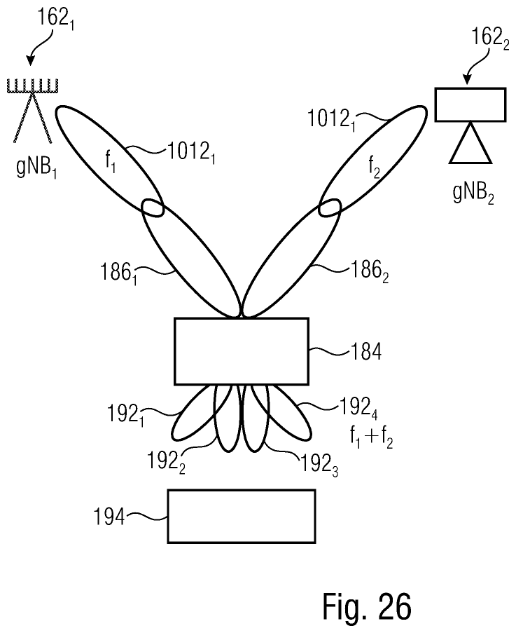

A smart repeater according to an embodiment may be configured for connecting or interconnecting two or more devices. For example, a SR can be connected to two gNBs, e.g., for interconnecting them or for extending the respective link of each of them, e.g., to a respective associated UE. The SR may forward such a respective signal on two different frequencies. Alternatively or in addition, a control channel for the SR can be established by use of only one of the frequencies. which is further explained in connection with FIG. 26 showing that a SR can be connected to two gNBs, which can be forwarded on two different frequencies and the control channel may sufficiently be implemented only on one of the frequencies.

SR Type 2 may be adapted to provide for DL signal processing functionality that allows it to decode channels that typically carry TDD information for the UEs, namely MIB and SIB1. In addition, it is envisaged that a base station can introduce additional DCI formats, specifically signalling repeaters, providing e.g. slot format indication. This means that SR Type 2 is capable of decoding PDSCH and PDCCH. Each of the repeaters may be configured for receiving and processing a control signal and to operate accordingly. Such a control signal may be received via a control channel in-band or out-of-band of the wireless communication network although a control channel is not mandatory. The control information is advantageously but not necessarily received as a wireless signal. Instead of or in addition to transmitting, to the repeater, a specific control signal, the repeater may determine instructions and/or other control information indirectly, e.g., by determining patterns in the resources or the like. For example, a use of specific beams, reference signals, resource configurations or the like may implicitly indicate instructions to the repeater.

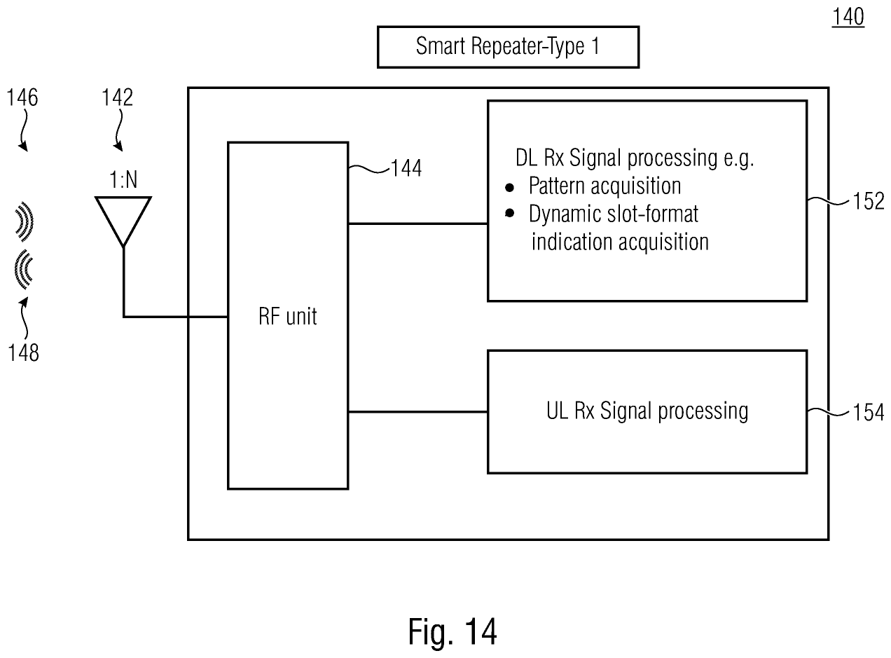

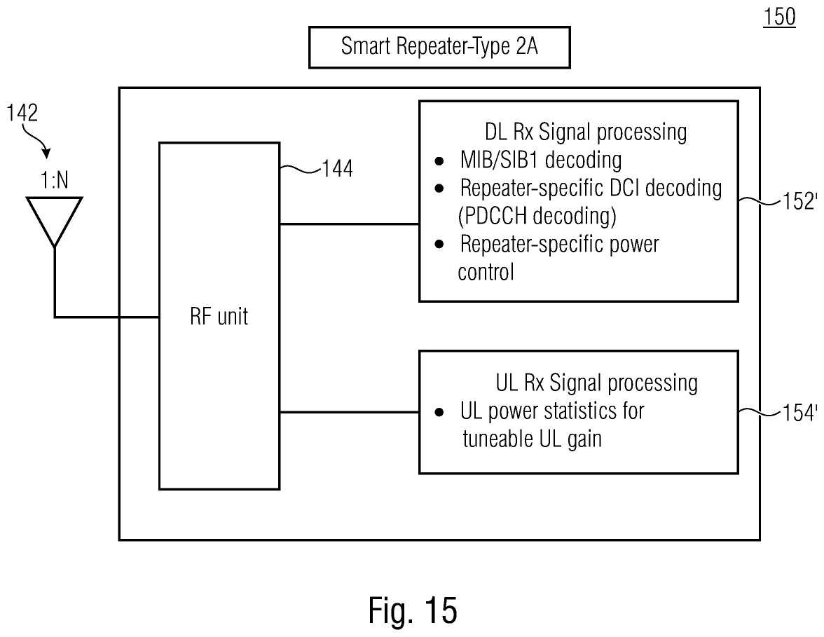

FIG. 14 shows a schematic block diagram of an apparatus 140 according to an embodiment that may be referred to as a smart repeater of Type 1. The apparatus 140 comprises an antenna arrangement 142 comprising at least one antenna or antenna element, wherein the antenna arrangement 142 may be operated as a receive antenna and a transmit antenna. Such a functionality may be split up to different antenna arrangements of the apparatus 140 that may also be implemented by a common antenna arrangement having one or more antenna elements. Alternatively or in addition, apparatus 140 may comprise more than one antenna arrangement, each of the antenna arrangements possibly used as arrangement for exclusively transmitting, for exclusively receiving or for transmitting and receiving wireless signals. An antenna arrangement such as antenna arrangement 142 may comprise at least one and at most N (1:N) antennas and/or antenna arrays. Optionally different antennas and/or radio frequency (RF) units may be shared or used between the mobile termination, MT, part and the repeater/forwarding part of the SR—SR/NCR-Fwd to enable both—at least one in-band and at least one out-band control channel.

Apparatus 140 is configured for communicating in a wireless communication network or wireless communication scenario.

The apparatus 140 may comprise a radio frequency, RF, unit configured to receive and pre-process radio signals such as a wireless signal 146 received with the antenna arrangement 142.

Alternatively or in addition, the RF unit 144 may be configured for providing a signal to the antenna arrangement 142 to coerce the antenna arrangement 142 to transmit a wireless signal 148. The RF unit 144 together with the antenna arrangement 142 may be referred to as radio unit. Without limiting the embodiments to a specific communication partner of the apparatus 140, in case the communication partner is a base station, the wireless signal 146 may be regarded as a downlink signal and the wireless signal 148 may be regarded as an uplink signal. However, the apparatus 142 may not only forward a signal from a base station to a UE or vice versa, but may also provide for a D2D communication between base stations and/or between non-base stations such as UEs.

The apparatus 140 may comprise at least one of a processing unit 152 for downlink Rx signal processing and a processing unit 154 uplink Rx signal processing. Although both processing units 152 and 154 may be combined with each other in a common processing unit, they may also be implemented as a respective standalone unit.

Whilst processing unit 152 may be configured for executing a limited downlink receive signal processing to obtain, for example, information about a communication mode, e.g., TDD and/or FDD mode, which allows to operate accordingly by possibly adapting reception and/or transmission of wireless signals to the communication mode, the processing unit may also perform a pattern acquisition, a dynamic slot-format indication acquisition or the like to determine the frame structure or other parameters of communication in which the repeater is operated. That is, the repeater may determine its used mode of operation by receiving and/or evaluating received signal 146, signal 146 being transmitted in uplink or downlink.

Alternatively or in addition, by use of the antenna arrangement 142 and the RF unit 144 the apparatus 140 may obtain information about an on/off mode, e.g., by monitoring a control channel. Such a control channel may be established between one or more entities of the network and apparatus 140, i.e., its MT part for exchange of configuration and control messages including, alternatively or in addition to an on/off configuration a status report or the like. An on/off information or control may be beneficial for network-controlled repeater to control the behaviour of NCR-Fwd, referring to the radio unit, i.e., antennas and the RF unit and configured as forwarding unit or forwarding part of the SR/NCR. Embodiments provide for a detailed mechanism of on/off indication and determination, e.g., to temporarily use or deactivate an NCR, e.g., based on a use of measurements. Embodiments relate to an explicit indication or implicit indication of such an on/off information. The ON/OFF information or control may be a part of information transmitted over the control channel or side information.

In other words, apparatus 140 may realize a smart repeater of Type 1 that may possibly be implemented for a limited signal processing. For example, it can be signalled by the base station using repeater-specific signals to operate in such a way. The RF unit 144 may be used for TDD and/or FDD and may contain all functions used for RF transmission and reception. The RF unit 144 may map signals to the appropriate antenna units of antenna arrangement 142 and the respective resource elements. However, this operation is combinable with additional functionality. Apparatus 140 may be configured for executing a limited DL receive signal processing to obtain the communication mode, e.g., TDD and/or FDD and may operate accordingly.

FIG. 15 shows a schematic block diagram of an apparatus 150 that may operate as a smart repeater of Type 2A. apparatus 150 may be configured for executing an extended DL receive signal processing being extended when compared to the limited processing of apparatus 140. Such an extended DL receive signal processing may be used to obtain the information about the communication mode. Alternatively or in addition, apparatus 150 may obtain, by use of the signal processing, specific signals and/or a sequence that indicates changes in a slot pattern or a symbol patter. Alternatively or in addition, apparatus 150 may decode a transmit power control command that is, by performing such a signal processing, e.g., on a control channel, the smart repeater may be controlled in view of an amplification to be implemented when forwarding a signal, with regard to an output power, e.g., a minimum output power and/or a maximum output power, in view of a band filtering, a spectral, temporal, and/or spatial receive and/or transmit filter, an implemented shaping, a beam forming, or any other specific input/output relationships. A limited signal processing such as UL signal processing and/or DL signal processing may include, for example, to only decode the information on TDD pattern and dynamic slot or even symbol indication. This can be signalled to the repeater using, e.g. a separate communication channel, using any combination of e.g. RRC signalling (TDD pattern), operation and management, O&M/OAM, configuration, or DCI indication for dynamic flexible slot/symbol indication (optional). Flexible symbols may be used, for example, for a control channel, c-link.

Alternatively or in addition, in relation to beamforming, limited signal processing may be implemented by just using switched beams on the backhaul and/or access, which can be signalled using pre-configuration, RRC signalling, MAC CE, DCI indication or any combination of these methods.

As a limited signal processing in DL and/or UL one may understand, according to embodiments, to perform only decoding the information on, e.g., a TDD pattern and dynamic slot or even symbol indication. This can be signalled to the repeater using, e.g. a separate communication channel or control channel. For example, any combination of e.g. RRC signalling (TDD pattern), O&M configuration, or DCI indication for dynamic flexible slot/symbol indication (optional) may be used.

Also, in relation to beamforming, limited signal processing may mean to just use switched beams on the backhaul and/or access, which can be signalled using pre-configuration, RRC signalling, DCI indication or any combination of these methods.

When compared to the limited signal processing, an extended functionality may comprise to enable a device to decode various (more) formats of DCI, relating to, e.g. DL PDSCH/PDCCH scheduling, PUCCH/PUSCH scheduling, ON/OFF and power control for the backhaul and/or access link (on the DL), decoding more extensive RRC signalling, including various System Information Broadcast messages, which can be introduced for repeaters only. We can also encode UCI, if the repeater has the transmitter towards gNB. Optionally, this may include a dynamic beam information for the access and backhaul link, e.g. via DCI and combination of O&M or RRC signalling. It should be noted that any form of signalling towards repeater, signalling being DCI, UCI, MAC CE, RRC, including system information messages, or the like, could rely on the current formats, fields, control elements. Alternatively, the signalling space of these signalling techniques could be extended to include repeater-specific CE, fields, formats etc.

When compared to the limited UL/DL signal processing, an extended functionality may comprise to enable a SR to decode various (more) formats of DCI, relating to, e.g. DL PDSCH/PDCCH scheduling, PUCCH/PUSCH scheduling, ON/OFF and power control for the backhaul and/or access link (on the DL), decoding more extensive RRC signalling, including various System Information Broadcast messages, which can be introduced for repeaters only. Embodiments relate to also encode UCI, if the repeater has the transmitter towards gNB.

Both, a dynamic indication and a semi-static indication may be implemented for the beam indication of the access link for the NCR-Fwd. According to embodiments, the maximum number of beams may be configured for NCR-Fwd access link, e.g., 1, 2, 3 or more, e.g., 4, 6 or 8.

An extended DL signal processing may alternatively or in addition include dynamic beam information for the access and backhaul link, e.g. via DCI and combination of O&M or RRC or MAC signalling.

A processing unit 152′ that is enhanced when compared to processing unit 152 of apparatus 140 may be configured for decoding a master information block MIB and/or a system information block of Type 1, SIB1, or for decoding DCI or a repeater-specific downlink control information, DCI, e.g., by decoding the physical downlink control channel, PDCCH, for implementing a repeater-specific power control or the like.

Alternatively or in addition, the apparatus 150 may comprise a processing unit 154′ that is enhanced, when compared to processing unit 154 of apparatus 140. For example, the processing unit 154′ may be configured for generating and/or evaluating UL power statistics e.g., for providing a tuneable UL gain or tuneable channel-gain, e.g., for a group of UEs in the uplink.

When compared to apparatus 140, apparatus 150 may be enhanced in view of one of the processing units 152 and 154 or in view of both of them.

In other words, FIG. 15 shows a SR of Type 2A that has extended Rx signal processing on the DL and may also include Rx signal processing functionality on the UL. The RF unit 144 may be used for TDD and/or FDD and/or any combination thereof (e.g. full duplex) may contain all functions used for RF transmission and reception and may map signals to the appropriate antenna units and resource elements.

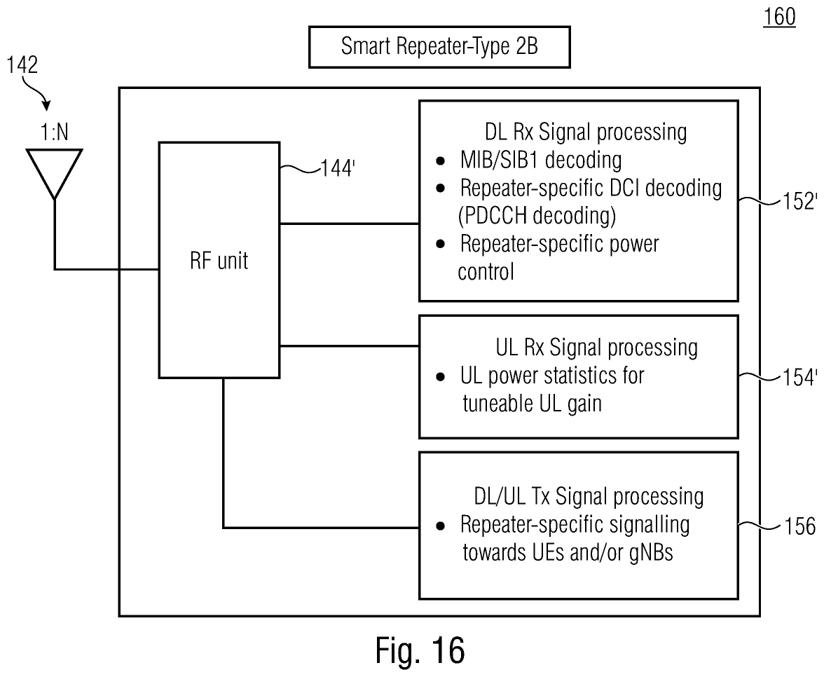

FIG. 16 shows a schematic block diagram of an apparatus 160 that comprises, when compared to apparatus 150, a processing unit 156 such that the apparatus is configured for executing a transmit signal processing in downlink and/or uplink. Such an apparatus may be referred to as repeater of Type 2B. For example, apparatus 160 may provide a repeater-specific signal towards other apparatuses such as UEs and/or gNBs which may allow the apparatus 160 to identify itself to the wireless communication network or the respective other apparatus using a repeater-specific ID or reference signal or other identifying information. For example, the apparatus 160 being a repeater may use RRC and/or a repeater specific RRC signalling. That is, by use of processing unit 156, the apparatus 160 may implement a repeater-specific signalling towards other apparatuses. Each of the apparatuses 140, 150, and/or 160 may be configured for establishing a control channel with a different apparatus to receive a control signal from said apparatus and/or to transmit a control signal to said apparatus. The control channel may be in-band or out-of-band the wireless communication network.

Embodiments relate to an implementation of apparatus 140, 150, and/or 160 as a mobile apparatus such as a drone or driving apparatus, being adapted for establishing a communication with at least one UE and for establishing communication with at least one base station, i.e., to forward communication between the UE and the base station.

For example, such an apparatus may be configured for establishing or maintaining the communication with the at least one UE for at least one base station during a moving mode or flight mode and for switching to a stationary mode or non-flight mode whilst further amplifying and forwarding signals.

Embodiments provide for the possibility to establish a beam management for the UE. For example, when using a Type 1 SR, a gNB may perform beam management for the UE, e.g., without assistance from the repeater. Alternatively or in addition, a use of a SR of Type 2A and/or Type 2B may allow for a beam management for the UE with assistance from the repeater.

In other words, FIG. 16 shows a SR of Type 2B that has extended Rx signal processing on the DL and on the UL. Furthermore, apparatus 160 may be adopted for generating, inserting, or creating repeater-specific transmit signals for the UL and/or DL. The RF unit 144′ may be used for TDD and/or FDD and any combination thereof (e.g. full duplex) and may contain all functions used for RF transmission and reception and may map signals to the appropriate antenna units and resource element.

According to an embodiment, the repeater operation may be transparent for the UE, e.g., in case the repeater is controlled by the network such as a control entity or a base station which may allow the at least one path component provided by the repeater to be recognised by the UE as any other path component. However, embodiments are not limited to such a transparent operation. According to an embodiment, that may be implemented as an alternative or in addition, the repeater may identify itself to the network and/or the UE and/or may mark path or identify its components which may allow, for example, to distinguish repeater-based path components from others and to select or avoid such f those marked path components by the UE. That is a repeater in accordance with embodiments, e.g., a Type 1 repeater may be transparent for the UE or make itself identifiable to the UE using specific reference signals, in terms of time-frequency patterns, spatial patterns, power levels or the like. Alternatively or in addition, b) Based on the reception of a control signal, e.g., received via a control channel, the repeater may enter an ON or OFF mode and/or may enter or switch between a duplex mode such as TDD, FDD or Full Duplex.

A Type 2A repeater may, based on the reception of a control signal, e.g., via a control channel,
mute transmission of reference signals during specific time-slots/symbols on the access link
change the time pattern of reference signal on the DL
decode transmit power control commands and subsequently change the power on the access link
perform beam switching, between e.g. preconfigured beams

A Type 2B repeater may, based on the reception of a control signal, e.g., via a control channel,
perform one or more or all of the above; and/or
perform more extensive decoding—e.g. of all DCI formats, including those that may be introduced for repeaters only
decode more extensive RRC signalling, including various System Information Broadcast messages, including repeater-specific introduced system information and dedicated RRC signalling that may be introduced for repeaters only
decode MAC CE for (modified) timing advance for the repeater,
decode MAC CE for beam indication or activation/deactivation of specific reference signals such as CSI-RS/CSI-IM on the access link
decode beam indication for the access link indicated via RRC, DCI, MAC CE or O&M messages
encode Uplink Control Information, which can carry acknowledgments with regard to DL control information,
encode MAC CE messages, which can carry acknowledgments with regard to DL commands
encode RRC messages (e.g. RRCReconfigurationComplete, Repeater-CapabilityInformation etc.).
perform adaptive beamforming on the access link, assisted by the gNB

Control information to be received and/or derived by the repeater, may relate to at least one of:
a gain factor to be applied for forwarding the wireless signal;
a power margin to be maintained
an power level of the signal transmitted by the apparatus to repeat the wireless signal;
a beam steering to be applied to repeat the wireless signal;
a directional and distance constraints for beam forming, e.g as black or white list
beam tapering (refinement), e.g. for sidelobe suppression
recovery beam candidates, e.g. in case of blockage or link failure
a beam sweep procedure
a beam pairing procedure
a beam set generation and identification with or without reference symbols (RS)
a timing or delay to be applied for forwarding the wireless signal;
a resource selection to be applied to repeat the wireless signal
a confirmation of executed commands responsive to the control information

For the mobile repeater scenario one can differentiate between at least two main relative mobility scenarios and combinations thereof:

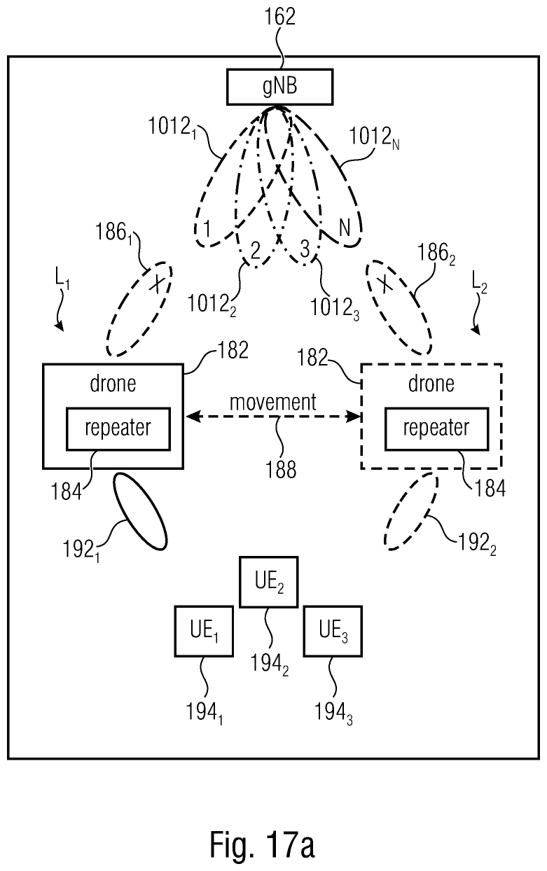

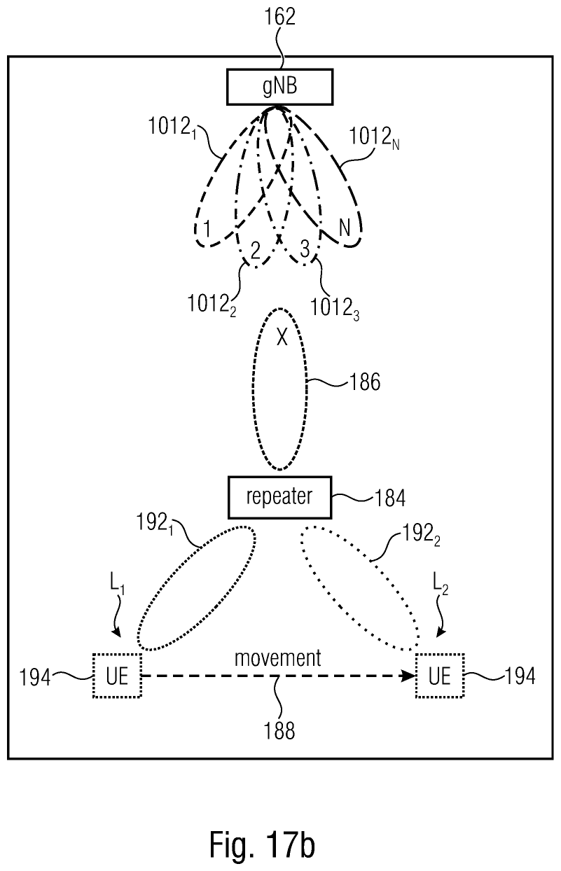

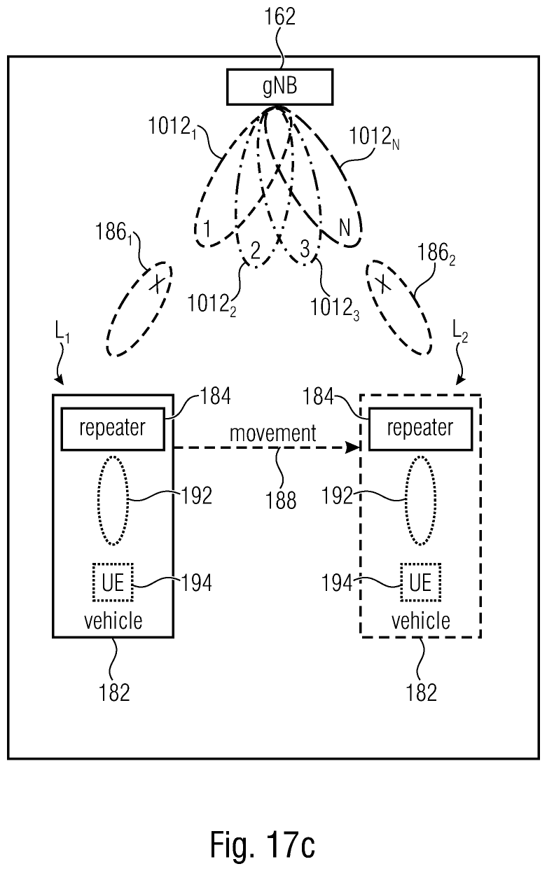

Scenario 1 describes mobility on the access link, while the spatial relationship between the SR and the UE remains fixed. This covers e.g. the case of a repeater mounted on a vehicle, covering the UEs inside the vehicle (bus, train, car, airplane). FIG. 17a shows a schematic block diagram of such a scenario 1 where a vehicle or moving object 182 is carrying a repeater 184 in accordance with an embodiment. The repeater 184 may be, for example, repeater 140, 150, 160, 170 or a combination thereof.

The vehicle 182 and thereby the repeater 184 is translatory and/or rotatory moving from a location or orientation L₁ to a different location or orientation L₂ thereby changing a relative position between the repeater 184 and a base station, BS, 162, that may operate at least partly as a known BS, e.g., BS 1024 and/or as a gNB. The repeater may form a different beam pattern 186₁ marked with “X” at location L₁ when compared to a beam pattern 186₂ marked with “Y” formed at location 186₂. This may allow to track the BS 162 with repeater 184 to compensate the movement 188. The BS 162 may track the repeater 184 by using different beams 1012₁ to 1012_{N}. Beams 1012 may be any beams, e.g., beams 1022 and/or 1032. The repeater 184 may operate a constant beam 192 towards a UE 194 based on an unchanged relative position between repeater 184 and UE 194.

In such scenario 1 the beam forming and tracking is mainly between SR and gNB therefore may exploit capabilities of the backhaul beam management. For example, at location L₁ the Without preclusion of other implementation options, an MT-like entity inside the SR may facilitate such backhaul tracking functionality. Link dynamics are mainly due to the mobile backhaul link.

Scenario 2 describes a fixed backhaul link and UE tracking at the access link. An example of scenario 2 is shown in the schematic block diagram of FIG. 17b where, when compared to FIG. 17a, the UE 194 moves relative to the repeater 184 by movement 188 causing repeater 184 to track the UE 194 by use of varying beam patterns 192₁, 192₂ respectively whilst an essentially constant relative position between repeater 184 and BS 162 may allow to maintain beam 186 unchanged. In such scenario, beamforming options like described in FIG. 5a may be beneficial, e.g., exploiting channel/beam feedback from the UE 194 to the gNB 162, which may forward control signals to the SR to control the beams on the access link. Link dynamic is mainly on the access link side.

Scenario 3 is a combination of the scenario 1 and scenario 2 and shown in an example block diagram in FIG. 17c. The vehicle 182 may be, for example an airborne SR (drone, balloon, airplane) which may possibly cover an underserved area with UEs inside, using a backhaul link to a further away gNB. When compared to FIG. 17a and FIG. 17b, the repeater 184 is moving relative to the BS 192 and relative to at least one UE 194₁ to 194₃ or a group thereof. Such a repeater 184 may be configured for tracking BS 162 as well as UE 194₁ to 194₃ by changing the beam patterns based on the change in the relative position. Such scenario may be conserved a standard use case for emergency services with first responders and entails beam tracking at the backhaul and access link.

The following sections address different aspects of functionality provided by or for the SR. Section 1 (Smart Repeater synchronization to the network) considers how the SR synchronizes to the network supporting different TDD and FDD modes automatically including coexistence considerations of coverage footprint overlap of several networks operated by different MNOs, both in quasi-collocation of non-collocated deployment variants. This means that the location the SR is deployed may be covered by a multitude of beams of the one and/or multiple gNBs, therefore becoming subject of time invariant or variant service and interference situations wherein it is expected that collocated and non-collocated deployments may entail different level of beam coordination.

Section 2 (Control Channel (CC) between Smart Repeater and network) addresses means to establish communication channels between the network and the SR for exchange of configuration and control messages including status reports, on/off etc.

Section 3 (Measurement framework for Smart Repeater-based network configuration) describes in detail the used measurement framework to operate SR as transparent to the UE as possible still allowing to observe the effects the SR has towards coverage, capacity, interference, handover etc.

Section 4 (Smart Repeater identification with a wireless link) proposes solutions enabling the identification of SR within a wireless link, considering both directions in the uplink and downlink and concatenated SR links.

Section 5 (Smart Repeater operational modes) describes different modes of operating a SR including Single Antenna Input & Single Antenna Output (SISO-SR), MIMO towards the gNB (backhaul link) and/or the UE (access link), fixed and/or flexible beams and coverage areas again on backhaul and or access link. Furthermore, this section includes different options and levels of smartness in terms of signal selection for forwarding in uplink and downlink.

Section 6 (Network optimization with Smart Repeaters) addresses enabling solutions to allow for efficient network optimization exploiting the smart features of SRs. Coverage extension by use of SR comes at the price of introducing additional inter-cell-interference (ICI) and potential confusion/unwanted interaction with other network optimization mechanisms/loops performed at the gNBs e.g. beams sweeps (SSB) for optimized illumination of the coverage area of a gNB in coordination with its neighbours.

Section 7 (Smart Repeaters authentication by the network proposes solutions how a SR can authenticate to the network to declare its existence, capabilities, configurations, conformance etc.

1—Smart Repeater Synchronization to the Network

This section describes, amongst others, messages and parameters to be read/monitored, that is the configuration exchange between SR and network (gNB and/or CN) SR should sync on DL signals from base stations (gNB) which should provide network and cell specific settings (MIB, SIB, DCI) e.g. to extract TDD structure, framestart, center frequency etc.

SR should sync on at least the strongest SSB received from at least one gNB
In case of simultaneous anchoring (backhaul) to distributed RRUs (DAS), multiple SSBs, multiple gNB or multiple bands (CA); SR should have main sync on one of the beams, gNB and monitor the other beams, gNBs on sync and changes in DL broadcast channels

2—Control Channel (CC) Between Smart Repeater and Network

This section describes, amongst others, messages space defining control and parameter, configuration exchange between SR and network (gNB and/or CN).

CC between SR and the controller can be anchored in the associated gNB(s) and/or core network (CN) or any other control entity
Example of a campus network wherein a number of SR are controlled by the local CN using off-the-shelf small/macro cells

CC can be inband (intra-RAT) LTE (NSA) or 5G-NR (SA and NSA) or outband (inter and/or extra-RAT) e.g. LTE, WiFi, over satellite
Inband channel could be implemented using a UE type receiver or transceiver with a SR specific ID e.g. SIM card to identify the SR via a user ID as part of the network and establish e.g. RRC connection for controlling the SR as a special device (UE) 4 this is similar to a certain extent to the MT concept used in IAB networks; the Network Controlled Repeater MT, NCR-MT, may be defined as a function entity to communicate with a gNB via Control link (C-link) to enable the information exchanges (e.g. side control information). The C-link is based on NR Uu interface
If MT functionality is provided, SR can be controlled by the gNB (CU) directly using the whole set of control commands available over RRC and data payload.
Outband CC can include:
   NB-IoT for simplistic authentication and rudimentary exchange of control messages to setup the SR operation, control some actions, responses etc.→such CC could be operated within 3GPP eco-system controlled by CN or OTT if NB-IoT is not connected to the same network.
   NTN-links using 5G or other non-3GPP RATs, the NTN link being attached to the same CN or as a non-3GPP OTT internet link.
A split control channel wherein a part of the control information e.g. configuration settings are provided via a side-channel and additional information (control information) for triggering, activation or deactivation of certain modes can be done in-band via Rx only by the SR. Further extension could include ACKs towards the network. This includes forced deactivation or reactivation of repeaters associated to BS cell ID or beam number. These actions are performed to control interference while providing coverage.

3.—Measurement framework for Smart Repeater-based network configurations

This section describes, amongst others, which specific messages are to be exchanged to configure UE for measurements and inform UEs about the explicit or implicit marking ID of the SR

Framework should be the already existing CSI and IM framework

UEs should be tasked to do specific measurements, including differential measurements associated to certain settings of the SR
Differential measurements could be triggered, synced by:
   Individual UE configurations using RRC messaging or
   Broadcasted flags in the MIB, SIB (1 . . . 7), DCI, CORESET to be monitored by the UE→allows orchestration of coordinated group measurements

SR should be tasked to respond/not-respond to particular SSBs and associated CSI-RS beams
Tasking can be semi-persistent, dynamic with OTA SSB detection and forwarding and/or based on anticipated/predicted repeated SSB occurrence patterns.
In response to configuration

4—Smart Repeater Identification within a Wireless Link

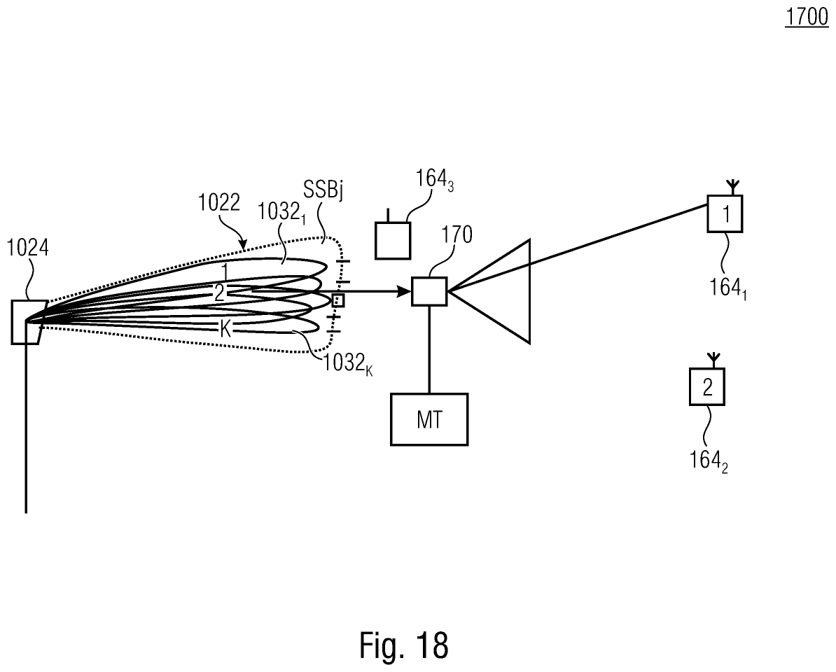

FIG. 18 shows a schematic block diagram of a wireless communication network 1700 comprising a BS 162, that may operate at least partly as a known BS, e.g., BS 1024 using several narrow CSI-RS marked beams 1032₁ to 1032_{K} within the coverage of the wider beamwidths of one SSB 1022. Assuming that the CSI-RS beams 1032₁ to 1032_{K} are long-term static with respect to direction, beamwidth and power the antenna of a repeater 170 that may be in accordance with apparatus 140, 150 and/or 160 towards the BS 162 will pick-up a subset of the provided CSI-RS beams 1032₁ to 1032_{K} above a given threshold, thus providing opportunities to distinguish such CSI-RS beams 1032₁ to 1032_{K} in terms of received signal reference power, RSRP. RSRQ and/or RSSI can also be used instead of or in addition to RSRP. Considering further, that the repeater 170 is forwarding all CSI-RS 1032₁ to 1032_{K} beams associated with a particular SSB beam 1022 towards the users 164₁, 164₂ on the access side, UEs within coverage of the repeater 170 will experience the received signal power ratios as well if the repeater is operated in fixed amplification mode. NOTE: if the repeater 170 is operated in fixed output power mode the UE would have to estimate the error vector magnitude EVM, and/or signal to noise ratio, SNR, per CSI-RS beam as a metric to distinguish their channel quality in terms of Channel Quality Indicator, CQ, Signal to interference plus noise ratio, SINR, etc.

Further details on the measurement framework to be found above in section 6 (Network optimization with Smart Repeaters). Herein concepts are disclosed relating to a method to estimate that UEs 164 are behind a repeater in DL and/or UL.

Since the feeder link of the repeater 170 is a kind of keyhole if operated with a single antenna array and/or single beam all UEs will observe the same relative channel quality for the CSI-RS beams 1032₁ to 1032_{K}, therefore reporting ranking, ordering or selecting best set of beams in a similar way or same way provided the UEs 164₁, 164₂ are identical and use identical software for decision making. As a result, similar channel feedback from a group of users may be an indication when analysed in the BS 162 that all UEs of this group experience a similar channel behaviour from the BS 162 to the UE 164₁, 164₂, which in the repeater case may be dominated by the repeater feeder link. Depending on the distance the reported RSRP may differ.

In the reverse link from the UEs 164₁, 164₂ to the BS 162 (uplink) Channel State Information, CSI, measurements performed at the BS 162 may provide further indications that UEs 164₁, 164₂ are operating behind a relay, since all incoming signals via the relay/repeater 170 contain identical multi-path components (MPC). Furthermore, in case the channel responses of two UEs 164₁, 164₂ behind the repeater are very similar, it is likely that such UEs 164₁, 164₂ are located closely to each other and sharing similar orientation and directional behaviour of their uplink beams.

Given the same spatial signature on the last hop to the BS 162, then the BS 162 can exploit beam correspondence and optimize the UL and DL beamformer towards the Smart Repeater (SR) 170. Furthermore, if the access link beam of the SR is kept fixed in space. polarization and power all established means for beam management between a UE 164₁, 164₂ and a BS 162 will work, given the fact that the BS 162 is more or less perfectly feeding into the repeater pick-up antenna. Furthermore, the BS can provide instructions to the SR Type 2 can, based on which, the SR can perform fine-tune beamforming on the access link.

If that exact match is not given and significant power spill around the repeater directly into the UE 164₁, 164₂ receive antenna is happening then ambiguity in beam management procedures may occur MT in FIG. 18 may represent a Mobile Termination that may be connected to repeater 170 and that may operate similar as in IAB. The MT may be a logical entity, which can receive side-control information for controlling the links of repeater 170 toward the UEs and gNB.

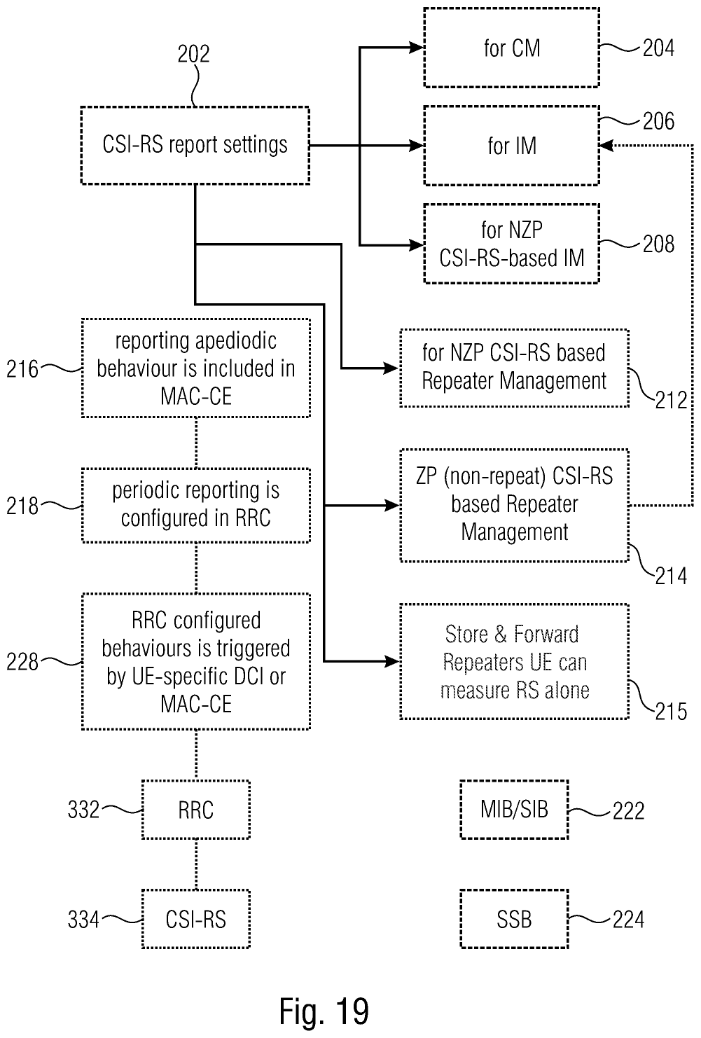

FIG. 19 shows a schematic illustration relating to a method for exploitation of existing beam management and CSI reporting schemes to determine if UEs are served by a Smart Repeater. In order to provide means to determine, e.g., by a base station 162 of network 1700, if a UE is behind a smart repeater or in a direct channel to the BS it is proposed to extend the existing CSI-RS reporting mechanism to allow detection mechanisms for Smart Repeaters in the channel between the BS and the UE. The new components serve the purpose of enabling the UE to identify if served by a SR and if in mixed mode (direct channel from the BS and exposure to the SR channel) to determine e.g. the received power ratio between the two channel components in a similar fashion like using the Rician factor to describe the received signal power of a LOS in comparison to the NLOS component. Zero Power (ZP) mode may also refer to Almost Blank Subframes (ABS) concept, as introduced in Inter-cell Interference Coordination (ICIC), wherein BS mute for certain subframes to improve channel estimation and interference measurement for UEs.

CSI-RS reporting 202 may be used for channel measurements (CM) 204 and interference channel measurements (IM), wherein IM can be performed using zero power, ZP, settings 206 and non-zero-power, NZP, settings 208 at the BS. ZP IM 206 measurement builds on the fact that the RS meant for a particular UE are switched off in a particular slot known to the UE and all measured received signal on these particular RS subcarriers can be attributed to interference coming from another source.

Such ZP combined with specific NZP settings can be signalled to the UE in a step 212 or 214 or simply applied to measure interference, e.g., caused by beams from the gNB. Store and Forward Repeaters/UE may measure the RS alone, step 215.

Furthermore, the UE can be configured to perform a-periodic measurements 216 and/or periodic measurements 218 (e.g., via RRC 332) and commands are then provided via UE-specific DCI and/or MAC-CE 228. RRC signalling 332 provides UE-specific signalling options, while using MIB, SIB and DCI provides group specific signalling in the SSB broadcast channel 224.

Using these means of configuring the UE measurement and reporting certain CSI-RS beams in a step 334 can be indirectly marked or flagged that these are likely to be received via a repeater.

By using the MIB/SIB/repeater-specific RRC/DCI messaging 222, a SR and the associated UEs to a particular set of CSI-RS beams are informed and signalled that certain settings are to be done and/or certain specific measurements to be taken and to be reported. The repeater-specific RRC/DCI, UCI or other signalling may be sent towards the repeater and/or sent by the repeater and may optionally include a repeater identification.

In this way it is possible to trigger the SR that e.g. it should change power settings including ON/OFF setting. This would enable UEs to measure a difference between SR in the loop or not in the loop. The difference of these two distinct measurements can be used to determine the power ratio of SR-channel/non-SR-channel, which provides an indication to which extent CSI reports are disclosing the SR dominant channel description and which part remains a direct channel component between BS and UE.

Furthermore, the ZP mode (switching the SR ON/OFF) provides means for active IM measurements based on CSI-RS.

The setting of the SR, how to interpret specific DCI/RRC/MIB/SIB flags can be configured/programmed/signalled via a side channel which can LTE, WiFi or any other suitable means or in-band by equipping the SR with some MT functionality allowing to establish SR specific RRC signalling with the BS.

Furthermore, the case of an initial out of coverage (OOC) scenario to the network should be considered, wherein the smart repeater (SR) is a smart mobile repeater (SMR), e.g. a bus, train and or UAV or drone. The additional features of the SMR beyond forwarding downlink signals from surrounding mobile networks include at least one of but are not limited to:
network coverage detection mode (repeater's search for DL signals of any and/or particular cellular networks),
a network-selective synchronization to time and frequency and forwarding of the DL and UL signals of one or more networks (SMR synchronizes onto signals of a particular network and its base stations)
identification towards the network as a repeater connecting one or more devices/UEs which are in OOC or partial OOC mode (SMR initiates e.g. a RACCH procedure wherein the network is informed that the SMR is bridging into an OOC area, wherein some of the devices/UE may not be subscribers of the network addressed as anchor for such OOC bridge)
network may provide/grant access to guest devices/UEs covered by the SMR by granting conditional network access when running through RACCH procedure and network subscription is checked, before network access is granted/denied.

SMR may signal to network, on behalf of one, some or all UEs in OOC area/mode which network subscription these belong to (such feature can be enabled if the SMR behaves towards the UEs like a stand-alone base station and analyses network authentication during RACCH), towards the network the SMR acts like a MT in IAB, executing a RACCH procedure and establishing RRC connection to the network.

In case of a UAV mounted SMR the bridging feature can be realized by the following procedure:
After activation the SMR is searching for available cellular networks/base station signals.
If no network is discovered—OOC scenario is concluded.
If in OOC, SMR activates transmission mode to “mimic” a PDCCH of a base station in order to trigger devices/UEs within range to start a RACCH. This may include frequency scans across several bands and “mimicking” different networks by changing PLMNs.
If UEs start RACCH, SMR may allow them to camp on the cell and/or signal capability to provide a bridge from the OOC area/mode.
After a reasonable time of exploring the OOC proximity and having collected a sufficient number of UEs in OOC mode, the UAV mounted SMR may activate/initiate the UAV module to autonomously take off and increase distance to the one or more UEs aiming to find a 3D-location allowing to identify a cellular network in far distance.
While flying and scanning 3D-space the SMR is constantly keeping wireless connection(s) to the one or more UEs in order to keep within wireless communication range.
When the UAV mounted SMR detects a cellular network successfully it will sync to such network and potentially authenticate to such network, wherein the authentication procedure may include at least one of the above described features and capabilities to be signalled.
When SMR is authenticated to the network, the SMR can start standard repeater operation by either:
   Enabling repeater mode towards the OOC area without announcement or
   Signalling to or configuring a handover (HO) or conditional HO to the network which is to be forwarded in repeater mode.
   In case of a link between the SMR and the one or more UEs is based on another RAT, e.g. WiFi or in an unlicensed band, e.g. ISM, NR-U the SMR can initiate initial communication via the ISM band or the alternative RAT
In this way the UAV mounted SMR can “fly” to a position which allows to bridge between a cellular network and an OOC region of this network or other networks as well.

That is, a repeater in accordance with embodiments may be a mobile apparatus, e.g., a drone, that is adapted for establishing communication with at least one UE and for establishing communication with at least one base station. For example, the repeater is configured for establishing or maintaining the communication with the at least one UE and/or at least one base station during a moving mode or flight mode and for switching to a stationary mode or non-flight mode whilst further amplifying and forwarding signals.

4.1—Detection of SR by UE Enabled by BS, e.g., gNB-Enabled SR Detection by UE

The invention provides for specific messages that may be exchanged to inform UEs about the explicit or implicit marking ID of the SR

Means to mark/identify a signal to be associated with a SR
Specific changes in the forwarded signal
Specific markers (RS, bits in MIB, SIB, DCI) associated with specific SSBs which are forwarded by SR
Differential SR identification by tasking measurements comparing Slots with SR on/off using almost blank subframe (ABS) techniques
   for parallel detection of several SR in a measurement
   for identification of concatenated SR links in UL & DL

4.2—Detection of SR by UE Assisted by SR, e.g., SR-Assisted SR Detection by UE

The objective of introducing repeaters is to reduce white spots and poor coverage areas while not increasing inter-beam interference significantly. A mechanism described herein enables a remote beam management of network-controlled repeaters referred to as reduced capability IAB nodes with the assistance from UEs, observing repeated signals, wherein the repeated signals may be marked with a repeater-specific sequences.
Repeater-specific marking may include:
   An SSB could be modified to signal two states AND the repeater is configured to respond by operating in Mode 1 or Mode 2, delayed or immediately AND/OR UEs is triggered to observe the channel on time-frequency resources associated with Mode 1 and Mode 2 and report within CSI framework
      This should be transparent to the UE as long as the CSI reporting can be reliably correlated with the operation-mode of the repeater
   Mode 1 or Mode 2 could be e.g. repeater active or repeater inactive OR two modes of partial frequency mode etc.
   Blanking or modulating specific time-frequency resources
   Adding or insertion of repeater-specific reference signals, e.g. in empty sub-carriers
A SR of Type 2B could identify itself towards the UEs by inserting specific messages in the PDCCH and or CORESETs described therein (a CORESET describes a time-frequency segment/area where specific information is to be found—such CORESET designated to be filled with signalling inserted by the SR can be encoded and broadcasted by the base station/network.
Furthermore, in OOC mode or during blank or almost blank (sub)-frames the SR could “mimic” a base station and transmit a typical SSB signature towards the UEs, wherein specific signals, identifiers etc. may allow the UEs to identify the presence of a SR and/or its capabilities/features. A UE could identify a repeater or being served by a repeater by observing the rank of the effective wireless channel from the base station. In case of only one transmit/receive antenna at the either backhaul or access side of the SR, the rank of the channel will degrade to ONE, representing a keyhole channel over the entire bandwidth. In case of a mixture of a repeated and direct channel with the base station the UE will identify a rank>1.

5—Smart Repeater Operational Modes

Detection and Reporting of Keyhole Channels

Forwarded channels can be considered as a concatenation of individual channel segments, wherein any degradation of spatial degrees of freedom will determine the overall spatial degree of freedom (channel rank) describing the amount of multipath propagation exploitable in the overall end to end channel from the gNB to the UE. A classic example is the case of a SR deployed in a rich multipath environment both at the backhaul and access side. But the repeater is equipped on one of the side with N and the other side with M antennas. As a result the overall channel rank will always be smaller than the minimum of N and M. If N or M is one then the end to end channel rank reduced to one which corresponds to a keyhole channel. An easy rank enhancement would be the use of dual polarised antennas and tow forwarding chains in the SR.

Spatial Modes: Single-beam and multi-beam support by SR (embodiments provide for messages that may be exchanged in order to keep in existing CSI framework e.g. type I and type II feedback),
Single beam at backhaul (static and switchable)
MIMO at backhaul (including polarization multiplexing and multi-beam support at the pick-up antenna directed towards the gNB)
Single beam and multi-beam at access link
MIMO at access link

Time slot and SSB specific forwarding of the SR (embodiments provide for messages that may be exchanged and in which order),
SSB puncturing
ABS (almost blank subframes) in DL &UL for interference management (IM) and SR identification (CSI)

SR could operate (embodiments provide for messages that may be exchanged and in which order), either:
Highly autonomous with simplified status reports on change of configurations and network feedback if a configuration is better/worse and/or to be kept/changed or
Assisted by network (core or/campus) via measurements by gNB for UL and/or DL or
Full or partial configuration control by network assisted via measurements in UL and/or DL

6—Network Optimization with Smart Repeaters

Embodiments provide for a method (procedures for measurements and optimization loops) to identify the effect of specific SR configurations (coverage sector, overlap with other SSBs, other cells, power control, mode of operation etc.)
For SR Type 2:
   UL Power can be different in the access and BH, and potentially configurable, even dynamically (e.g. Slot-format)
   Gain of the repeater should be adaptive (i.e., controlled autonomously or in response to signals from one or more UEs and/or basestations)—the repeater can act as an UL range extender
   gNB can control the power of UEs, so they can be scaled up (limited by max power) or down
   gNB can control the repeater to work on certain altitudes, velocities, regions, locations, defined geographical areas (important for UAV mounted SMR)
   Regarding Transmit Power Control (TPC) for the repeater, gNB knows the absolute power level or power headroom of UEs. Base station can use repeater gain as tuneable channel-gain for group of UEs in the UL. The channel gain can be configurable on the slot-level.
   An SR can be configured to respond to a signal from one or more UEs and/or to signals from one or more basestations (i.e., network or networks).
   An SR can be configured to “mimic” a basestation so as to trigger a RACH.
Both repeater types can:
   be switched ON and OFF, dynamically. Beam control on BH and access link is optional.
   use frequency translation as a method to mitigate interference.
   Type 1—observe and follows the instructions from gNB,
   Type 2 can respond with more than ON/OFF. Type 2A Rx and detect only from the base station, and Type 2B can transmit message such as UCI. It can respond with the message. Type A can only responds by acting/behaviour.

Embodiments relate to the topic how to tasks UEs to perform measurements coordinated with specific actions/configurations by the SR(s)

7—Smart Repeater Authentication by the Network.
Capability signalling of repeater type
Activation/deactivation
Could be realized over inband or outband CC using MT(UE) functionalities via SIM card
Could be realized over outband CC using:
   SIM card e.g. LTE or NB-IoT as RAT or
   Other certified tokens to identify the SR

Identification of a Smart Repeater to identify the Repeater and/or a path component or multipath component

To make a repeater described herein identifiable based on signals it transmits allows for further purpose, e.g., to identify a path or route of the transmitted signal when further considering additional information like a position of the repeater. By making the repeater identifiable, thereby path components or multipath components that are generated by the smart repeater or that rely on it may become identifiable for a receiver that receives the signal.

Alternatively or on addition, the identification of the smart repeater may be basis on a repeater-specific information transmitted by the repeater, i.e., a transmitter-specific information. Such information may be included at a predetermined position indicated, e.g., by a base station that indicates resources of, e.g., a CORESET, into which a repeater shall include its transmitter-specific information. According to an embodiment, a repeater described herein, e.g., repeater 140, 150, 160 and/or 170 may be configured for inserting a repeater/transmitter-specific information into a predetermined resource, e.g., a time and/or frequency resource of, e.g., a CORESET of a frame of the wireless communication network responsive to receiving corresponding instructions received from the wireless communication network. This may be understood as inserting the repeater-specific information into the repeated signal, i.e., the signal transmitted by the repeater which makes it identifiable, at a receiver, that the signal was received from a repeater, the specific repeater respectively. The repeater may be configured for inserting the transmitter-specific information as an identifier that tags a path component, e.g., a multipath component created by the apparatus or to tag the apparatus. According to further embodiments, an apparatus making use of the repeater may actively select the path component or the multipath component for transmitting a signal towards said direction or receiving from said direction, e.g. as is knows that the component may be reliable. According to an embodiment, the transmitter-specific information is specific for a group of apparatus or for an individual apparatus.

It may be of advantage that repeater devices provide for information via an active signal generated, for identifying an MPCs as well as for positioning purposes.

According to an embodiment there is provided the wireless communication scenario, wherein the wireless communication scenario is configured for instructing at least one repeater to insert a transmitter-specific information into a predetermined resource, e.g., a time and/or frequency resource of, e.g., a CORESET, wherein the repeater is configured to operate accordingly. That is, a base station may leave some specific resources unused and the repeater may insert its information and a member can use such received information. According to an embodiment there is a wireless communication scenario, wherein the member is configured for receiving the transmitter-specific information and for using the transmitter-specific information as an identifier that tags the path component.

According to an embodiment there is a wireless communication scenario, wherein the transmitter-specific information is specific for a group of repeaters or for an individual repeater. Such insertion may be orchestrated within the network to allow for multiple advantages.

According to an embodiment there is a wireless communication scenario of, wherein the member is configured for identifying the repeater or the path component based on a received transmitter-specific information, e.g., for communication purpose and/or for positioning purpose.

That is, a repeater may use space (time resources and/or frequency resources) of an empty or partially empty CORESET to add specific signals. The location may be known or expected at a receiver. If the signal space is well designed, then a receiver can distinguish between different MPCs, when receiving a superposition of a few or more than a few such signals. Such empty CORESETs could be provided by the gNB in regular intervals. Similar to almost blank subframes. Repeaters may be synced to frame structure and optionally compensate for timing advance. Such a repeater may be configured for repeating a signal to be repeated received from a second apparatus, e.g., a BS or a UE, and for determining, based on an instruction indicated in the received and processed control signal, a modified timing advance when compared to a timing advance of the source of the signal to be repeated. The repeater may repeat the signal based on the modified timing advance.

With regard to aligning timing or reception and/or transmission, the impact of internal delay on the following timing relationships may be addressed: a) the DL receiving timing and DL transmitting timing of the NCR-Fwd; and/or b) The UL transmitting timing and UL receiving timing of the NCR-Fwd.

A control channel that may be used for instructing the SR, e.g., established between the SR and gNB can be anchored in a control entity or coordinator node. Such a control entity may be located within a repeater or collocated with a repeater. Considering that the control entity and the SR are advantageously time-aligned, the internal processing delay may be taken into account. For example, in the UL, different timing advances may be applied to different UEs and the control entity. Hence, there may be a group timing advance applied for all UEs (e.g. based on the timing advance of the furthest UE), which is different than the timing advance from the control entity to the gNB. There may also be internal delay within SR caused by switching between DL and UL or any other function. Hence, embodiments provide for a solution to consider different requirements of time to implement such delay that may impact UL transmission timing of the repeater and the control unit. For example, in a wireless communication network, the base station or the control entity may be configured for controlling a set of apparatus to implement a controllable delay individually for each of the set of apparatus to timely align communication of the set of apparatus.

In principle the repeater should be aligned with the TDD frame structure provided by the gNB, taking into consideration of timing advance (TA) between SR and gNB. Furthermore, the TA and TDD switching at the most far-away UE will further shift the switching time from DL to UL, therefore further exploiting the flexible frame, slots and symbol structure provided in NR. Since the SR is overlaying an additional switching pattern onto the one provided by the gNB, some time resources may not be exploitable in DL and/or UL and should be excluded from UE scheduling by the gNB,

Authentication may be of benefit to announce the SR in the network and/or to provide the wireless communication network with information about a presence and/or capability of the SR. This may allow the wireless communication network, e.g., a base station or a coordinator node, to select a SR to participate in a communication or to form a part of a path of the communication based on the available information.

According to an embodiment, an apparatus such as a SR, e.g., repeater 140, 150, 160 and/or 170 may be configured for authenticating to the wireless communication network. For example, the apparatus may comprise a mobile termination, MT, and is configured for performing an authentication procedure with the wireless communication network, e.g., using the MT that may have a subscriber identity module, SIM, or the like. Alternatively or in addition, the apparatus may be configured for authenticating to the wireless communication network based on joining the wireless communication network, e.g., during a power-up, reboot, coming into a coverage of a base station, of the network or like. During authentication, the repeater may report one or more of the following: a presence, a location, at least one path component provided, e.g., a respective identifier or the like, a capability, e.g., a MIMO capability on the access side and/or the backhaul side, signal processing capabilities, supported operation modes, in particular operation modes that may be controlled by the network, a remaining or scheduled time of operation, a remaining battery level, a travel route, a speed of the apparatus or any other relevant information.

Such information may be accessed by the network, e.g., for selection and/or coordination of a use of repeaters, e.g., to optimise an overall throughput, minimise interference or the like. For example, a base station may select one or more from a set of available repeaters according to a requirement of the communication with a specific device and/or of the overall communication. Embodiments do not preclude a UE to select or request a use of a repeater for communication. That is, the UE may request the repeater or the network to base its communication on a selected repeater to initiate the use from the access side.

Beside the authentication, also different sources of information are provided in accordance with embodiments so as to provide a basis for a UE and/or the network side, e.g., a base station or a coordinator node. For example, an apparatus such as a UE may be configured for obtaining context information from another network entity to determine at least a part of the determination result that indicates that the communication of the apparatus is based on a repeater. Such context information may indicate at least one operational mode of the repeater, options of the third apparatus relating to at least one of the first apparatus and the second apparatus. Such options may relate to an interaction, a dependency a signalling or the like that the repeater apparatus may provide for the UE and/or the base station. For example, this may allow to determine one or more certain capabilities of the SR and how it is relates to the UE and/or BS to allow for optimising communication. Alternatively or in addition, context information may include one or more of:
relationships between the apparatuses,
a state, condition an apparatus is in
band of operation, repeater enhanced frame, slots, bandwithparts, duplex schemes
relevant KPIs for link optimization
capability of a device,
history log files;
energy, signalling constraints;
amplification gain and/or margin;
beam directions/patterns;
etc.

Alternatively or in addition, the apparatus may be configured for obtaining capability information from another network entity to determine at least a part of the determination result, the capability information indicating at least one operational mode of the third apparatus, that is controllable by at least one of the first apparatus and the second apparatus.

For example, knowing which capabilities and/or operation modes supported by the repeater may allow for an efficient selection and/or control of components participating in the communication, e.g., to control a repeater into a desired mode of operation for further use thereof.

Further Solution Components

Single, some or all of the following advantageous modifications may be implemented in sources, repeaters and/or sinks of signals to be repeated, repeated signals respectively, alone or in combination.

The objective of introducing repeaters is to reduce white spots and poor coverage areas while not increasing inter-beam interference significantly. A mechanism in accordance with embodiments may enable a remote beam management of network-controlled repeaters that may be called reduced capability IAB nodes with the assistance from UEs, observing repeated signals, wherein the repeated signals may be marked with a repeater-specific sequences.

To control the behaviour of an NCR at least for an access link, e.g., by a remote beam management as described herein may benefit from respective beam information to refer to a beam or identify a beam, especially for FR2. Embodiments therefore provide for a mechanism for indication and determination of beam, e.g., by identifying a respective multipath component.

Whether and/or how to handle the forwarding of broadcast and cell-specific signals/channels may be implemented for each cell separately or globally within at least a part of a larger area of the network or scenario. From the perspective of signalling design, following mechanisms can be considered for the access link beamforming of the NCR-Fwd. Option 1: Dynamic beam indication only; Option 2: Semi-static beam indication only; or Option 3: Dynamic beam indication and semi-static beam indication.

For example, for implementing an access link beam indication, an access link beam can be indicated by: a beam index. Such an index may be supplemented by information indicating a corresponding time domain resource of the beam. Alternatively or in addition, the index may carry said information already.

Alternatively or in addition, an index of a source RS (e.g. a TCI-like indicator) may be used. The source RS is then defined in the network or cell. An instructing or requesting part of the link may indicate the corresponding time domain resource of the beam, e.g., based on a definition of the association between the source RS and the beam in the network.

Features of at least some of the embodiments:

The repeater may have some intelligence to update e.g. a look-up table on the SSB. What this means is that the repeater may respond on some SSBs and not on others, i.e., to selectively respond on SSBs. The repeater may forward signals from one or more basestations, on different carriers/bands. The repeaters can then repeat different SSBs per a carrier selectively using filters. This should be configurable by e.g. macro base station. Different SSB carriers' combinations do not necessarily have the same structure of beams (e.g. the beamwidths can be different), hence (repeater has to know which beam from which base station and which frequency it should repeat and when).

If there is a repeater branch/tree structure (concatenation of repeaters, the keyhole may be revisited, e.g., by a respective control).

The repeater may be configured for determining information indicating the UL-DL structure by RRC signalling or by detecting MIB and SIB.

The repeater may comprise a control channel for beamforming.
Control channel may be a side channel-in-band or some other auxiliary channel, which is used by the macro-base station to have a closed-loop channel with the repeater. It may be used for beam management towards the UE. The UE may send the feedback to the base station (via repeater), which is possibly not decoded by the repeater. Based on this information, the base station may instruct the repeater how to manage access side of the link.
Controlling the actions of the repeater—it can used as out-band or in-band, similar to IAB-MT, IAB Mobile Termination.
On the other hand, the repeater may not be required to have full capability for beam management. In other words, it does not necessarily handle the user feedback. The BS is instructing the UE to do something. BS and repeater need to coordinate.

The repeater may perform the mapping into the sphere. Certain SSBs may not be useful for the repeater while some SSBs can be white-listed. The repeater can be informed on which BF direction SSBs should not be used.

If codebook-based precoded CSI-RS is used, channel estimation and beam management are simplified for the UE.

As a side information, repeater may also try to detect and measure CSI-RS on the white listed SSBs.

UEs may provide a feedback about particular SSB or multiple SSBs. If the mapping is changed, it could be slow.

Bidirectional amplify and forward—the input BF for the BH and output BF for the access. It needs at least the envelope detector.

A TDD-repeater may use the knowledge about the TDD structure, e.g., receiving it or deriving it on its own.

If there is one beam for the backhaul, BH, on the Access side, more than one beam, combine it with the knowledge on the UL (MIB/SIB).

According to an embodiment a repeater is possibly unable to decode or configured to at least temporarily skip decoding. UEs scheduled on a certain SSB, encoded UE specifically=>as much as possible use signalling from the BS, beam management for the access side of the IAB node.

Add capability to the UE so that it believes that the connection is made via the macro cell. Marking: cellD, subnet, labelling structure.

The UE may report back the feedback, e.g., to the BS or the repeater. UE may report specifically on the modulated signals. For example, Type 2 feedback, as signals are coming from two different locations. The BS may use knowledge that the UE is behind the repeater.

The feedback may be important as it may be addressed to the BS and it is coming via a repeater.

SSB-specific TA as amplified by repeater (macro vs repeater).

Knowledge may be used originated from the UE whether a certain SSB is measurable at a certain location and if it is direct reception or via a repeater.

Beams targeted for users served by the repeater may be forwarded while one, some or all other beams are not forwarded or maybe muted (at the repeater), which allows to enhance the overall throughput.

The network NW/BTS may signal to the repeater: either when to repeat or mute; or follow a certain sequence which is identifiable by reading messages from MIB/SIB/SSB. This can be done using messages and/or sequences:
Messages: These may be sent using MIB or SIB and the repeater may be configured to decode them. A message could take the form of a certain known pattern.
Sequences: These may be sent in a particular resource element which signals a specific repeater action (e.g. forward, do not forward). That is, instead of or in addition to transmitting, to the repeater, a specific control signal, the repeater may determine instructions and/or other control information indirectly, e.g., by determining patterns in the resources or the like.

Network-assisted repeater forwarding control (NARFC) (a bent-pipe repeater with ON/OFF control)
Such a repeater may A specific DCI format scrambled together with repeater specific RNTI is used to signal UL/DL resources which are relevant for all UEs served by the repeater (such a repeater may have MT functionality as in IAB and the BTS is aware of a group of UEs served by the repeater and creates a multi-UE scheduling map).
In connection with NARFC, UE specific topics include:
   CSI reports from the UE can be labelled “observed behind repeater”, e.g. by tagging or other mechanisms described herein
   UEs can estimate and report a ratio of direct-versus-repeated channel power
   UEs may be informed by the BTS that they are potentially served by repeaters and about repeater specific markers and how the UEs should report certain observations

Having described the advantageous implementations and usage of a repeater in a wireless communication network, reference is further made to an apparatus such as a UE configured for communicating in a wireless communication network, for example, UE 164.

Together with or independent from an apparatus such as a UE, also a base station or other organizing node may benefit from the use of a repeater. Such an apparatus may be configured for communicating in a wireless communication network. The apparatus is a possibly a first apparatus and is configured for determining, that communication within the wireless communication network and with a second apparatus comprises repeating of a signal by a third apparatus to obtain a determination result; and for adapting the communication in the wireless communication network based on the determination result; and/or transmitting a signal, to the second apparatus, using a channel inside or outside the wireless communication network, the signal indicating instructions requesting the apparatus to perform measurements in the wireless communication network to obtain a measurement result, the measurement result indicating whether the communication to the second apparatus comprises repeating of a signal by a third apparatus.

According to an embodiment, such as an apparatus, e.g., a base station, is configured for communicating in a wireless communication network being operated in a time division duplex, TDD or a frequency division duplex, FDD, mode, wherein the base station is configured for:
transmitting a signal to a third apparatus, the signal indicating instructions regarding a TDD or FDD pattern used in the wireless communication network and/or slot format indication requesting the third apparatus to perform changes in a slot/symbols/TDD or FDD pattern when repeating a signal (e.g., for a type 1 repeater); and/or
transmitting a signal to the third apparatus, the signal indicating specific a signal/sequence to instruct the third apparatus to perform changes in a slot/symbols/TDD or FDD pattern used in the wireless communication network or power control commands to reconfigure the third apparatus (e.g., for a type 2A repeater); and/or
transmitting a signal to the third apparatus, the signal indicating a specific signal/sequence to instruct the third apparatus to perform changes in slots/symbols/TDD or FDD pattern or power control commands; and/or to transmit/insert/replace a specific message/signal into the repeated signal, e.g., a forwarded stream in which a type 2B repeater may insert signals (e.g., for a type 2B repeater).

According to an embodiment, the apparatus is adapted for obtaining information that repeating the signal relates to a channel rank of the communication and for adapting the communication based on the channel rank.

According to an embodiment, the apparatus is configured for identifying a path component of the wireless communication network based on a received transmitter-specific information received at a predetermined resource, e.g., a time and/or frequency resource of, e.g., a CORESET of a frame of the wireless communication network with a signal received from the transmitter.

According to an embodiment, the apparatus is configured for instructing at least one apparatus to insert, when operating as a transmitter a transmitter-specific information into a predetermined resource, e.g., a time and/or frequency resource of, e.g., a CORESET.

Further embodiments relate to methods for operating an apparatus such as a UE described herein, a base station described herein and/or a repeater described herein.

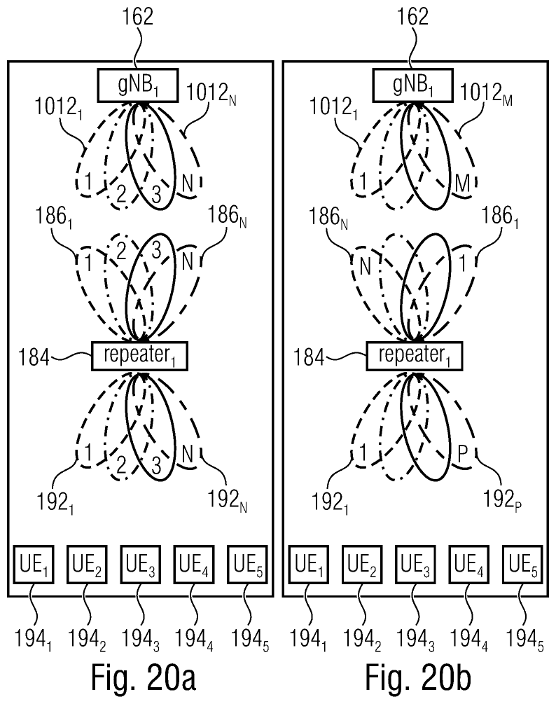

FIG. 20a and FIG. 20b show a schematic block diagram of a behaviour of a repeater according to an embodiment. Regardless whether it is implemented, e.g., as Type 1, Type 2A or Type 2B repeater a most suitable beam is determined for communication between gNB and the repeater, and repeater and/or with one or more UEs. According to FIG. 20a-b, a multi-beam communication may be established by the repeater on the backhaul side (to the base station(s)) and/or on the access side (to the UE(s)). A number of beams formed or formable with the repeater 184 towards the gNB 186 may correspond to a number of beams 1012, e.g., beams 1022 and/or 1022) that the gNB 162 may form as shown in FIG. 20a (N=N) or may be different as shown in FIG. 20b (N vs. M), wherein in such a case M may be larger than or smaller than N. The number of beams 192 formable with the repeater 184 towards the UEs 194 may be of a same number when compared to the number of backhaul beams 186 as shown in FIG. 20a or may be different with a number of P being larger than or smaller than N as shown in FIG. 20b.

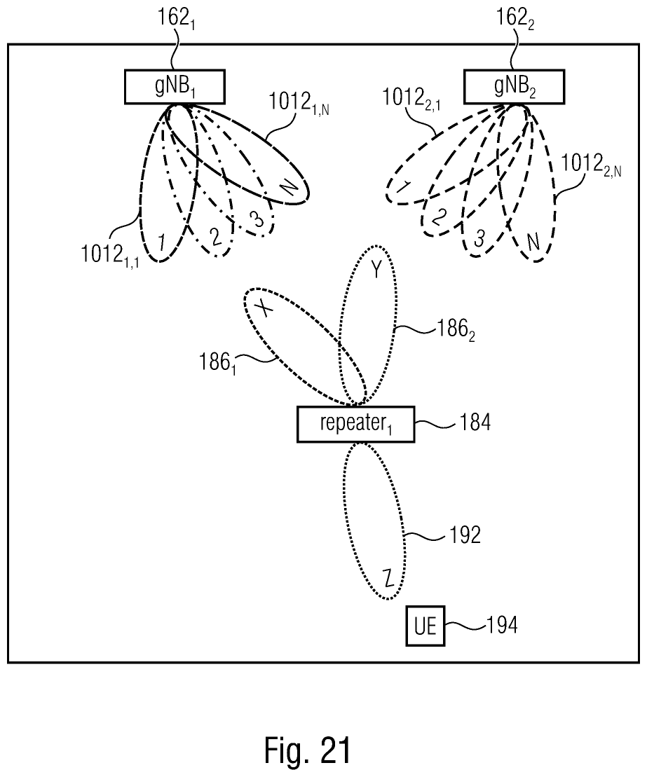

FIG. 21 shows a schematic block diagram illustrating a scenario according to an embodiment according to which the repeater 184 is configured for simultaneously or sequentially connect to more than one base station 162₁ and 162₂, e.g., a number of at least 2, at least 3 or more, and to forward or relaying communication of the plurality of base stations 162₁/162₂ to the UE 194, e.g., to implement handovers or multi-connectivity. Possibly but not necessary this may incorporate to form beams 186₁ and 186₂ towards the respective BS 162₁ and 162₂. For forwarding, a static or dynamic beam 192 may be used. Such a behaviour may be implemented for more than one UE at a time for same, partly different or completely new sets of base stations. According to FIG. 21, the repeater 184 may be connected to multiple gNBs.

FIG. 22 shows a schematic block diagram of a scenario in which repeater 184 maintains more than one link with the base station 162₁, e.g., one link along a line-of-sight (LoS) path 284 and at least one link along a non-line-of-sight (nLoS) path 286 that comprises reflection or scattering at an object such as a building 288. The UE 194 may provide for feedback, to the gNB 162 which links are to be used, according to the Type II feedback described in connection with FIG. 8 and FIG. 9, whilst actually the repeater benefits from the set of beams 1012₂ and 1012_{N} provided by the gNB for the benefit of providing data for the UE 194. This does not preclude communication of repeater 184 and/or UE 194 with a further base station 162₂. The repeater 184 may have MIMO capabilities at the backhaul side and/or the access side for supporting type II feedback.

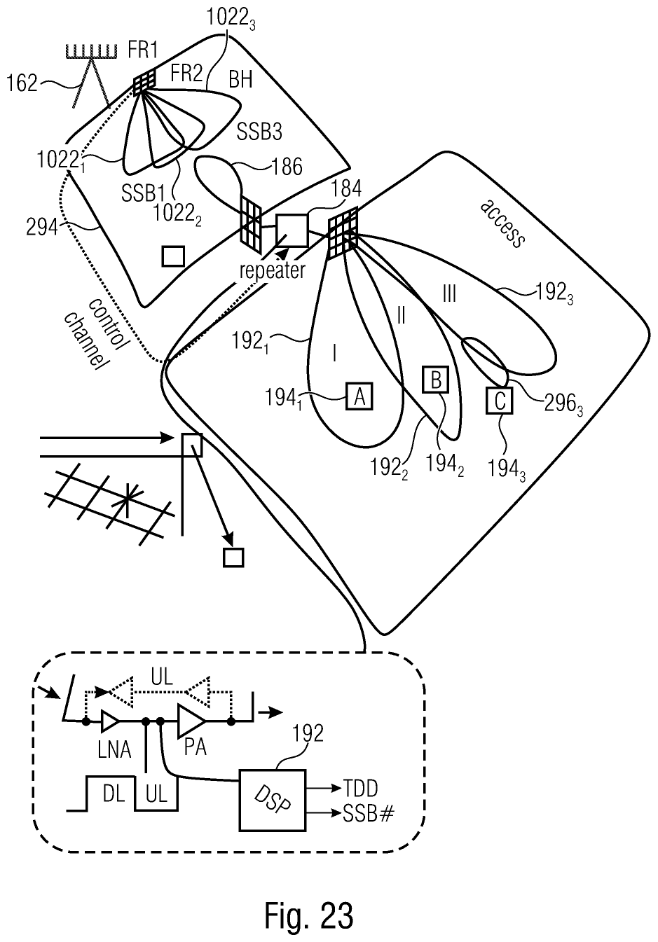

FIG. 23 shows a schematic illustration of a scenario having a SR 184 wherein the signal processing for DL detection of messages from gNB 162 and UL transmission to gNB 162 are processed by a digital signal processor DSP 292 inside SR 184. In the example, the repeater unit 184 may be of an Amplify and Forward type and may comprise a power amplifier PA. The repeater 184 may be configured for performing an access-side beam sweep or beam set selection which may possibly be assisted by the gNB 162. Based thereon UEs 194₁ to 194₃ may be detected and served with communication, e.g., based on a response from UE 194₃ forming a proper beam 296₃. gNB 162 may support FR1 and FR2, wherein FR2 may be of benefit especially for the backhaul, BH, link with the repeater 184. An in-band or out-of-band control channel 294 may be established between the network side, e.g., gNB 162 on the one side and the repeater 184 on the other side.

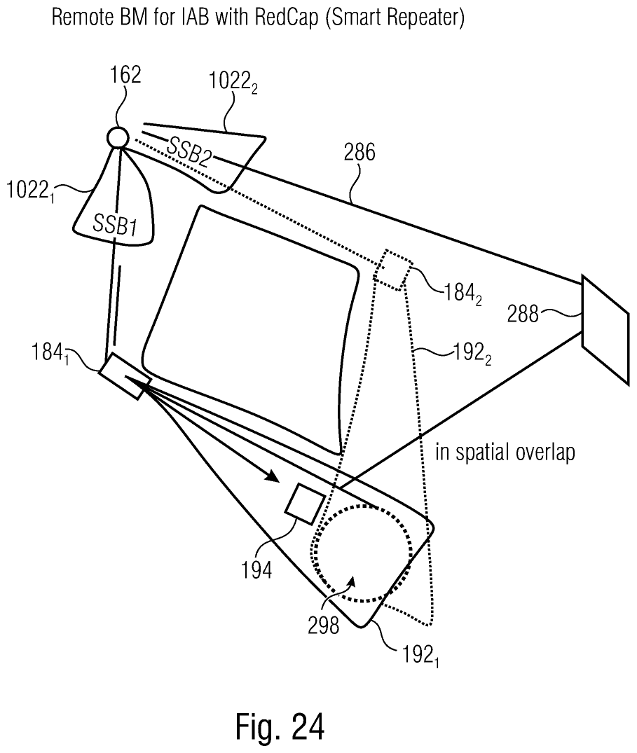

FIG. 24 shows a schematic illustration of a scenario in which a multi-repeater reception scenario at the UE 194 is implemented by use of more than one repeater, e.g., at least 2, at least 3 or more repeaters 184₁ and 184₂. The plurality of repeaters provide for a coverage by use of respective beams 192₁ and 192₂ which may spatially overlap in an overlap area 298. This may allow a UE 194 to benefit from both connections in the overlap area 298. A forwarding of a link using SSB2 or beam 1022₂ does not preclude the UE 194 to benefit from other multipath components, e.g., non-line-of-sight-path 286 enabled by object 288. This may lead to a situation where the UE 194 may experience a direct LoS or nLoS path 286 and a repeater-based path.

A direct path and a multipath component may result in different Timing Advance, TA, e.g. per SSB. This may be addressed, for example, by excluding one of the deviating SSBs from communication, e.g., beam 1022₂, and/or by using a TA specific for a respective SSB to compensate for different path lengths, e.g., between 1022₁ and 1022₂ to arrive at area 298. According to embodiments, a repeater may be marked, e.g., by marking signals sent with the repeater 184, e.g., by use of a specific power profile, pattern or sequence. The markers may, for example, be provided by the gNB 162, for example, use of an instruction or configuration, e.g., a kind of neighbourhood list. A marker may be block chained, e.g., to allow a use of multiple hops whilst preserving prior markers when marking a later hop, especially when using a number of more than 2 hops, e.g., at least 3, at least 4 or more.

The UE 194 may report, e.g., to repeater 184, gNB 192 or a different node, whether a received signal or path component was received directly from the gNB 162 or was forwarded by a repeater.

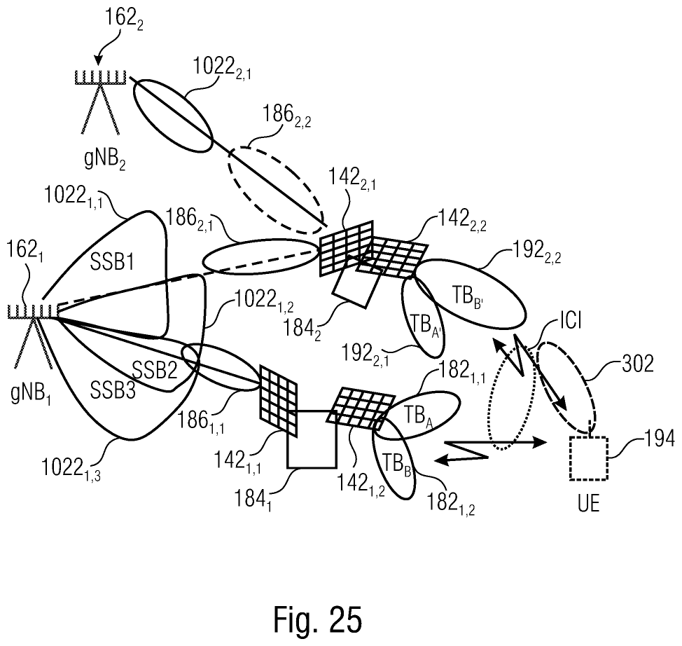

FIG. 25 shows a schematic block diagram of a scenario in accordance with embodiments, that addresses inter-channel-interference, ICI, that is induced by use of multiple repeaters. A UE 194 may experience ICI, e.g., on a receive beam 302 adapted for beam 192_{2,2} provided by repeater 184₂, e.g., using an antenna arrangement 142_{2,1}. Repeater 184₁ may cause, e.g., ICI with beam 192_{1,1}, wherein different reasons for ICI or other types of interference may arise in scenarios addressed with embodiments. By use of a remote beam management, i.e., a control of beams used by repeaters 184₁ and/or 184₂, e.g., by use of a coordinator node, such interference may be reduced or avoided. For example, a repeater in accordance with an embodiment, may receive a signal containing instructions to activate a specific beam and/or to avoid use of a specific beam, e.g., by deactivating it at least temporarily. For example, repeater 184₂ may be instructed to use beam 192_{2,2} and/or to not use beam 192_{2,1}, the latter possibly allowing to avoid suffering of another device from interference. Alternatively or in addition, the repeater 184₁ may be instructed to deactivate beam 192₁ to prevent UE 194 from suffering ICI.

The remote beam management for SR or IAB nodes with reduced capabilities may be implemented, e.g., time slot wise in the cell, e.g., for a BH-link using beams 186 and/or by use of beam mapping, e.g., for the access links using beams 192. A polarisation multiplexing, MUX, may be used at the BH side and/or a beam multiplex may be used at the access side. A type 2 feedback may be supported via the relay, SR. Embodiments introduce ways of relay-specific markers on repeated signals to distinguish components of the SFN-channel. The remote beam management may benefit from an inter-gNB coordination, i.e., to not only coordinate by a single base station but to also coordinate over a plurality of base stations, in particular of a plurality being part of a same or even of different networks. The remote beam management may be organised or determined, e.g., at a base station or a coordinator node, wherein a coordinator node may have knowledge about communication associated with more than one base station of one or more than one networks. A base station may be informed about beamforming used at the RS, e.g., by a coordinator node or a different entity.

FIG. 26 shows a schematic block diagram of a wireless scenario having at least two base stations 162₁ and 162₂ operated by same or different network operators and comprising repeater 184 that may maintain more than one links in the backhaul, e.g., to a respective base station 162₁ and 162₂ or a different node. One or more of said links may be used for an exchange of control information whilst such an exchange may alternatively or in addition be exchanged out-of-band. The links associated with respective beams 186₁ and 186₂ may be operated at different frequencies f₁ and f₂ but may commonly forwarded to at least one UE 194 or a set thereof or a respective location.

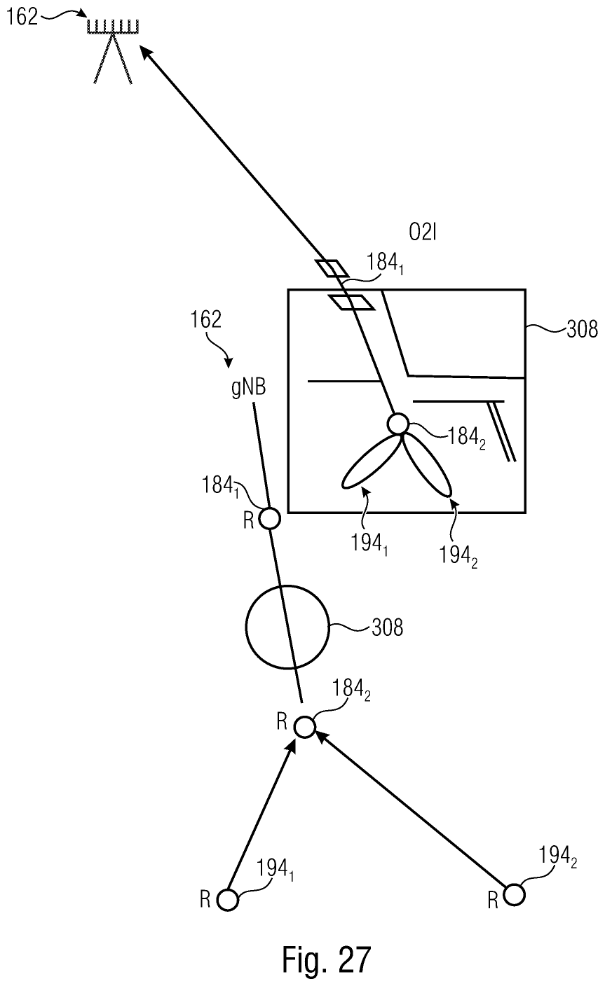

FIG. 27 shows a schematic block diagram of a scenario to illustrate a keyhole effect when going outdoor-to-indoor of a building 308 with a single antenna repeater.

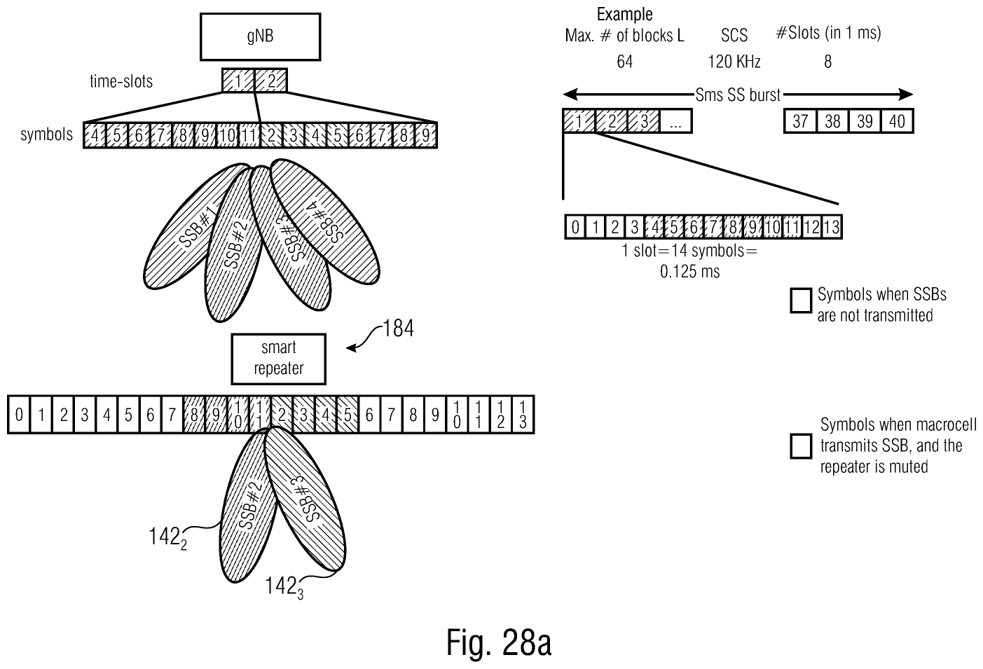

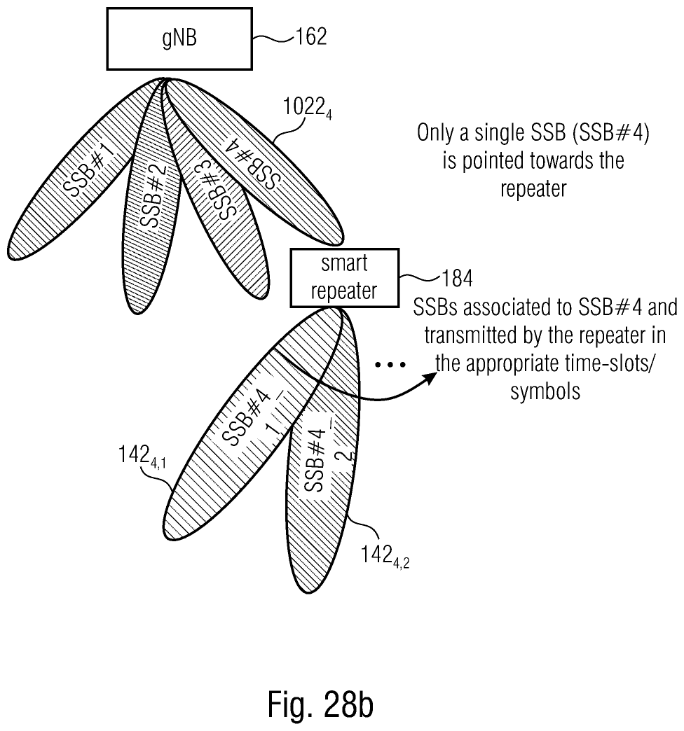

FIG. 28a shows a schematic block diagram of a SSB transmission in a scenario with SR. The example of time-domain behaviour by a repeater is depicted. The repeater 184 may muted during symbols or time-slots that are not transmitting SSBs pertinent to them. A sweep may be executed during the 5 ms SS burst. For example, in a system where a small number of beams is implemented, e.g., much less than 64, then many slots may not carry an SS beam. Even if implementing 64 beams, still 8 slots do not carry the SS blocks.

FIG. 28b shows a schematic block diagram of a scenario where, when compared to the embodiment of FIG. 28a, only a single SSB 1022₄ is received by the SR 184. The SR 184, on the other hand, may be configured, according to the embodiment, to receive instructions, e.g., from the network such as the base station 162 or a different authorised entity, to beamform the SSB in different directions on the access side in the appropriate time slots/symbols, for example, to not to interfere with other gNBs SSBs. This is illustrated by the example number of 2 beams 142_{4,1} and 142_{4,2} wherein any other number or pattern may be selected.

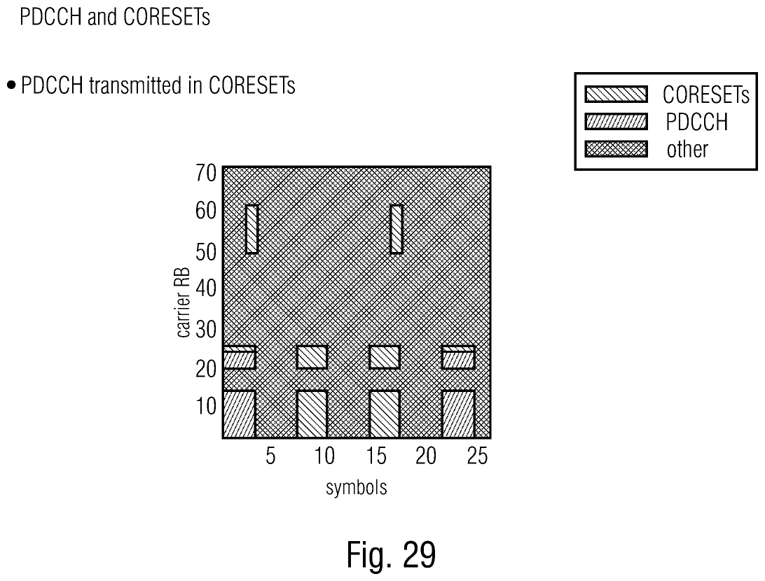

FIG. 29 shows a simulation result indicating that a physical downlink control channel, PDCCH, may be always transmitted within a CORESET. A configured CORESET does not need to carry PDCCH.

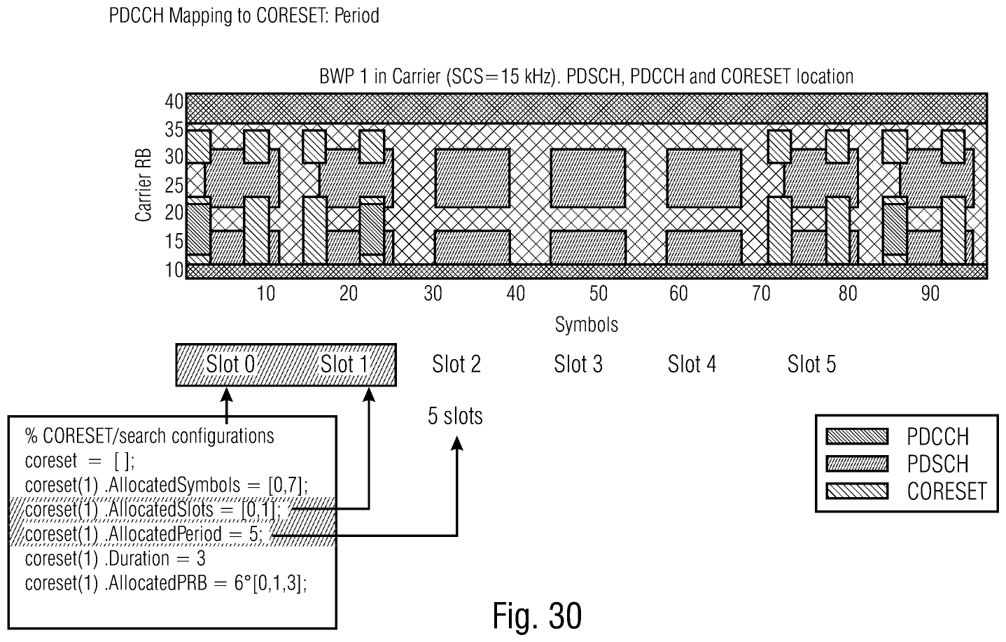

FIG. 30 shows a schematic representation of a possible PDCCH mapping to CORESET.

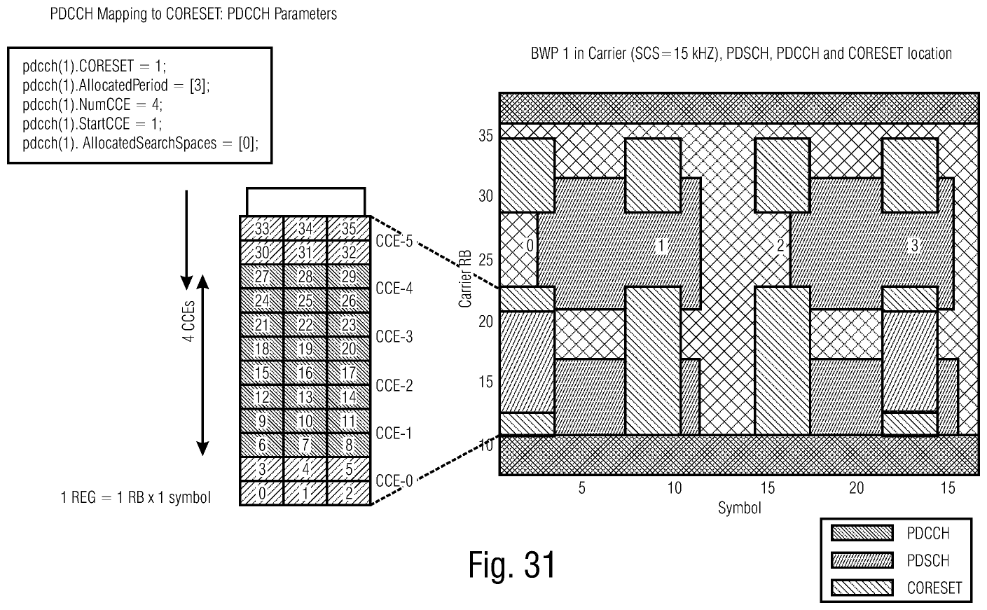

FIG. 31 shows a schematic representation of PDCCH parameters that include a number of Control Channel Elements, CCE, aggregation level etc. Namely, the resource elements in a CORESET are organized in RE groups (REGs). One REG is one resource block i.e. 12 REs in frequency domain and one OFDM symbol in time domain. A Control Channel Element is a combination of multiple REGs. A PDCCH is carried by 1, 2, 4, 8 or 16 CCEs to accommodate different DCI payload size or different coding rates. Each CCE consists of 6 REGs.

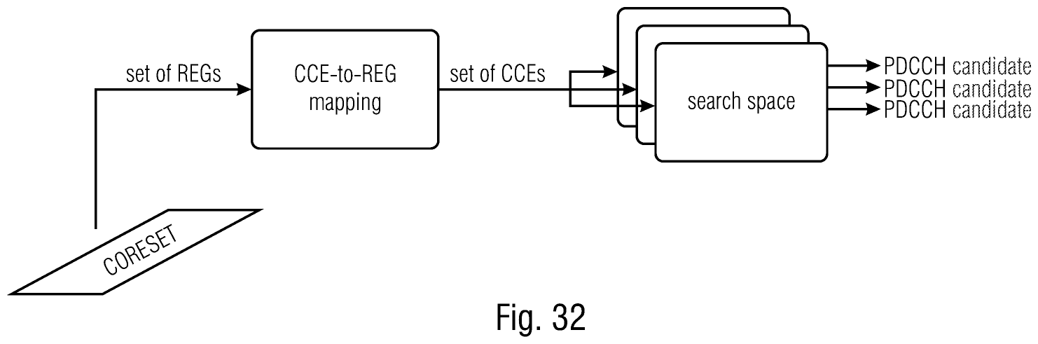

FIG. 32 shows a schematic block diagram illustrating an overview of PDCCH processing in NR.

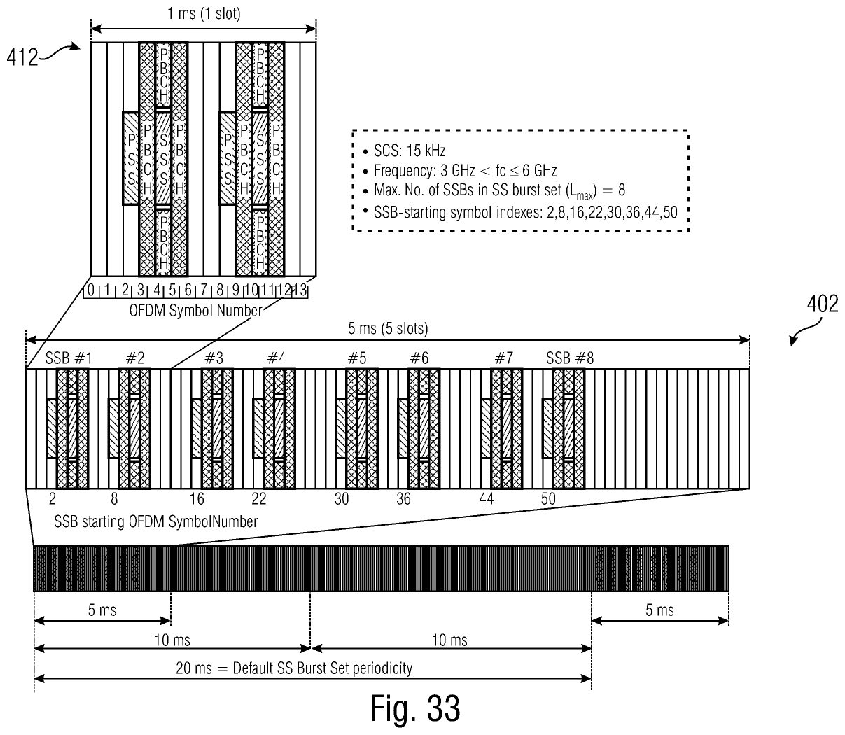

FIG. 33 shows a schematic representation of an example showing an SS burst set 402 comprised of eight SS blocks 412 which span fourteen OFDM symbols. In this example, the eight SS blocks 412 fit within the first slot (1 ms). By default, the SS burst may be repeated after twenty slots (20 ms).

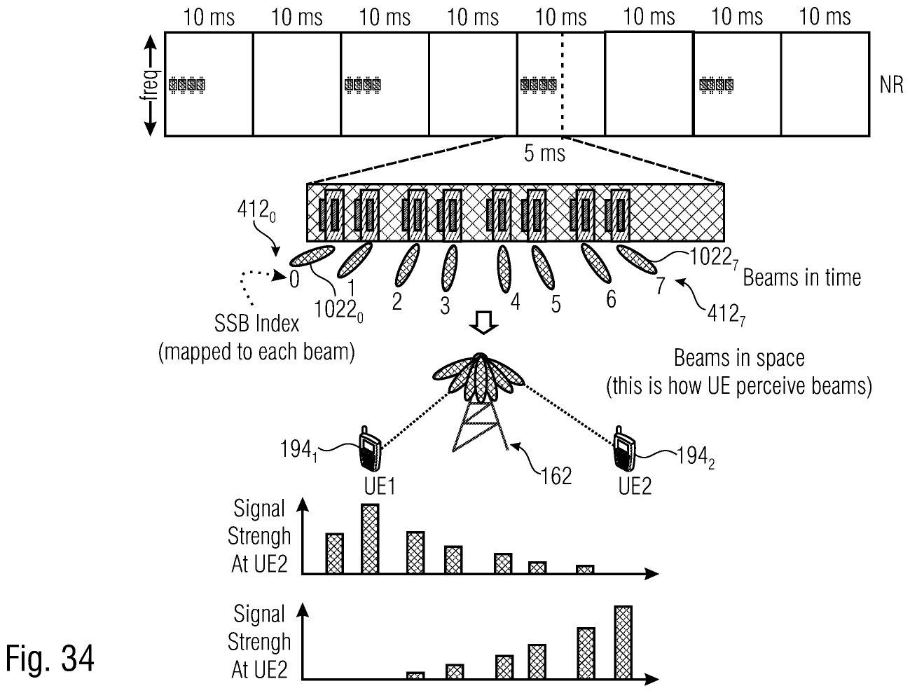

FIG. 34 shows a schematic representation of how the eight SSBs of, e.g., FIG. 32, comprising indices (0 . . . 7), are mapped to eight beams 1022 which are arranged to provide coverage in different directions. The received signal strength at two different UE locations is also shown.

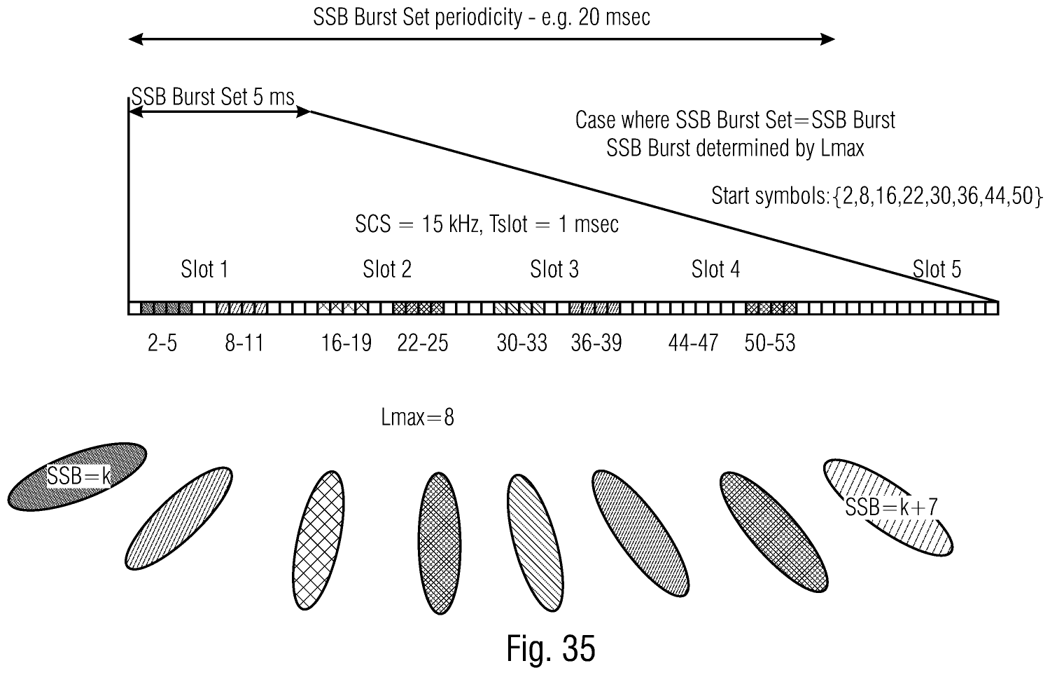

FIG. 35 shows a schematic representation of an SSB Burst for subcarrier spacing, SCS,=15 kHz and Lₘₐₓ=8 in time domain.

Embodiments in accordance with the present disclosure relate to an apparatus such as but not limited to a UE.

According to an embodiment, such an apparatus is configured for communicating in a wireless communication network, wherein the apparatus is a first apparatus and is configured for determining, to obtain a determination result, information indicating that a communication to a second apparatus, e.g., a base station/gNB within the wireless communication network is based on a third apparatus such as a repeater repeating a signal transmitted to the first apparatus or from the first apparatus. This may be described as determining information indicating that the UE is behind a repeater—measurement or even a derived meaning thereof. The apparatus may transmit a signal containing information indicating that the determination result, e.g., for reporting that the UE is behind a repeater; and/or may adapt the communication based on the determination result, e.g., for adapting control as being behind a repeater.

According to an embodiment, the apparatus is adapted for
obtaining information that repeating the signal relates to a channel rank of the communication to determine the determination result; and for
adapting the communication based on the channel rank.

According to an embodiment, the apparatus is adapted for
obtaining information that repeating the signal relates to a direction, e.g., of a signal path, of the communication to determine at least a part of the determination result; and for
adapting the communication based on the determined direction.

According to an embodiment, the apparatus is adapted for
obtaining information that repeating the signal relates to a delay, e.g., along a signal path, of the communication to determine at least a part of the determination result; and for
adapting the communication based on the determined delay.

According to an embodiment, the apparatus is adapted for
obtaining information that repeating the signal relates to a specific signal component property of the communication to determine at least a part of the determination result; and for
adapting the communication based on the determined specific signal component property, wherein the specific signal component property is at least one of:
   rank of the channel
   spatial signal path component(s) aka direction
   delay of signal path component (s)
   power of signal path component (s)
   a time frequency resource

According to an embodiment, the apparatus is configured for obtaining location-related information from another network entity to determine the information indicating that the communication to the second apparatus is based on the third apparatus, the location-related information indicating at least one of the an angular direction of a reference signal, a position of the second or the third apparatus, a position of the apparatus itself. For example, this may allow to determine a deviation between direct path and repeater-based path. Some information on the transmitted signal such as angular directions of reference signals or position of gNB, UE or SR may be obtained through another network entity such as e.g. LMF, data bases etc.

According to an embodiment, the apparatus is configured for obtaining context information from another network entity to determine at least a part of the determination result, the context information indicating at least one operational mode of the third apparatus, options of the third apparatus, e.g., information indicating interactions/dependencies/signalling, relating to at least one of the first apparatus and the second apparatus, e.g., to determine a certain capabilities of the RS and how it is relates to the UE and/or BS

According to an embodiment, the apparatus is configured for obtaining capability information from another network entity to determine at least a part of the determination result, the capability information indicating at least one operational mode of the third apparatus, that is controllable by at least one of the first apparatus and the second apparatus.

According to an embodiment, the apparatus is configured for
transmitting a first signal directly to the second apparatus together with transmitting the first or a second signal directly to the third apparatus, to cause the third apparatus for forwarding to the second apparatus; and/or
receiving a third signal directly from the second apparatus together with receiving a fourth signal directly from the third apparatus, the fourth signal being forwarded to the first apparatus by the third apparatus.

According to an embodiment, the apparatus is configured for identifying a path component of the wireless communication based on a received transmitter-specific information received at a predetermined resource, e.g., a time and/or frequency resource of, e.g., a CORESET of a frame of the wireless communication network with a signal received from the transmitter.

According to an embodiment, the path component is used by the third apparatus, e.g., repeater, for forwarding a signal to or from the apparatus.

According to an embodiment, the apparatus is configured for identifying the path component by at least one of
a propagation path delay;
a power delay spectrum,
a path direction
an angle of arrival, AoA,
a received signal strength (RSSI, RSRS) wherein part of the received signal comes directly from the second apparatus and another part comes from the third apparatus

According to an embodiment, the apparatus is configured for identifying the path component by determining of a metric, e.g. a power ration between a direct path, e.g., gNB to UE, and an indirect path, e.g., gNB to SR and SR to UE.

According to an embodiment, the apparatus is configured for reporting the metric to the wireless communication network. For example, this may relate to a power ratio that may be a reportable channel feedback which describes how much influence the SR has on the overall channel between gNB and UE and vice versa.

According to an embodiment, the apparatus is configured for reporting at least a subset of identified path components, a parameter or value derived thereof and/or an action determined from an identified path component to the wireless communication.

Embodiments in accordance with the present disclosure relate to an apparatus such as but not limited to a base station, e.g., a gNB.

According to an embodiment, an apparatus, e.g., a base station, is configured for communicating in a wireless communication network, wherein the apparatus is a first apparatus and is configured for
determining, that communication within the wireless communication network and with a second apparatus, e.g., a UE, comprises repeating of a signal by a third apparatus, e.g., a repeater, to obtain a determination result; and for adapting the communication in the wireless communication network based on the determination result. This may relate to determine whether UE is behind a repeater. Alternatively or in addition, e.g., for instructing the UE to measure if it is behind a repeater, the apparatus may be configured for transmitting a signal, to the second apparatus, using a channel inside or outside the wireless communication network, the signal indicating instructions requesting the second apparatus to perform measurements in the wireless communication network to obtain a measurement result, the measurement result indicating whether the communication to the second apparatus comprises repeating of a signal by a third apparatus.

According to an embodiment, the apparatus is configured for receiving a report containing a metric or identification of a path component that is provided by the third apparatus for the second apparatus; wherein the apparatus is configured for determining, based on the report, a measure indicating how much influence the third apparatus has on the overall channel between the apparatus and the second apparatus.

According to an embodiment, the apparatus is configured for receiving, from a network entity information indicating a beamforming to be applied by the base station so as to form a part of an coordinated beam management of the wireless communication network. That is, the base station may be informed about beamforming used at the RS.

According to an embodiment, the apparatus is configured for receiving, from a network entity information indicating a beamforming to be applied by the third apparatus so as to form a part of an coordinated beam management of the wireless communication network. For example, the base station is informed about beamforming used at the SR.

According to an embodiment, an apparatus, e.g., a base station, is configured for communicating in a wireless communication network being operated in a duplex mode, wherein the base station is configured for:
transmitting a signal to a third apparatus, e.g., a repeater, the signal indicating instructions regarding a Duplex pattern used in the wireless communication network and/or slot format indication requesting the third apparatus to perform changes in at least one of a slot, a symbol and a Duplex pattern when repeating a signal, e.g., to operate a Type 1 Repeater; and/or
transmitting a signal to the third apparatus, the signal indicating a specific signal/sequence to instruct the third apparatus a) to perform changes in at least one of a slot, a symbol, and a Duplex pattern used in the wireless communication network; or b) provide power control commands or beamforming commands to reconfigure the third apparatus, e.g., to operate a type 2A repeater; and/or
transmitting a signal to the third apparatus, the signal indicating a specific signal/sequence to instruct the third apparatus to a) perform changes in at least one of a slot, symbol, and a Duplex pattern or b) to provide power control commands or beamforming commands; and/or c) to instruct transmit/insert/replace a specific message/signal into the repeated signal, e.g., a forwarded stream in which a type 2B repeater may insert signals, e.g., to operate a Type 2B repeater; and/or
transmitting a signal to the third apparatus, the signal indicating a specific signal/sequence to instruct the third apparatus, a) to perform changes in at least one of a slot, a symbol, a Duplex pattern or b) power control commands or beamforming commands; and/or c) to transmit a specific message to the apparatus, e.g. a command execution confirmation, a measurement result, a status report, a capability information, etc, which may relate to cover MT response capability towards the base station, when SR can process and respond to protocols similar to a UE.

According to an embodiment, the apparatus is configured for selecting the third apparatus to participate in the communication from a set of apparatus being authenticated to the wireless communication network.

According to an embodiment, the apparatus is configured for accessing information indicating at least one of:
a condition of the third apparatus;
a presence of the third apparatus;
a capability of the third apparatus;
a path component provided by the third apparatus;
a signal processing capability of the third apparatus;
a supported operation mode of the third apparatus;
a remaining or scheduled time of operation of the third apparatus;
a remaining battery level of the third apparatus;
a travel route of the third apparatus; and
a speed of the apparatus
and for selecting the third apparatus based on the accessed information.

According to an embodiment a base station apparatus is adapted for obtaining information that repeating the signal relates to a channel rank of the communication and for adapting the communication based on the channel rank.

According to an embodiment a base station apparatus is configured for identifying a path component of the wireless communication based on a received transmitter-specific information received at a predetermined resource, e.g., a time and/or frequency and/or spatial resource of, e.g., a CORESET in a frame used in the wireless communication with a signal received from the transmitter.

According to an embodiment a base station apparatus is configured for instructing at least one apparatus, e.g., a repeater to insert, when operating as a transmitter a transmitter-specific information into a predetermined resource, e.g., a time and/or frequency resource and/or spatial resource of, e.g., a CORESET, beam.

According to an embodiment a base station apparatus is configured for obtaining context information from another network entity to determine at least a part of the determination result, the context information indicating at least one operational mode of the third apparatus, options of the third apparatus, relating to at least one of the first apparatus and the second apparatus.

According to an embodiment a base station apparatus is configured for obtaining capability information from another network entity to determine at least a part of the determination result, the capability information indicating at least one operational mode of the third apparatus, that is controllable by at least one of the first apparatus and the second apparatus.

Embodiments in accordance with the present disclosure relate to an apparatus such as but not limited to a repeater.

According to an embodiment, an apparatus, e.g., a repeater, configured for communicating in a wireless communication network, wherein the apparatus is configured for
receiving a wireless signal;
obtaining, from the wireless communication network, control information indicating at least one of an information about an ON/OFF mode; and information about a communication mode; and
operating according to the obtained control information for repeating the wireless signal.

According to an embodiment, the apparatus is configured for obtaining the control information from the wireless signal; and/or for receiving a control signal containing the control information.

According to an embodiment, the control information indicates at least one of:
a gain factor to be applied for forwarding the wireless signal;
a power margin to be maintained
an power level of the signal transmitted by the apparatus to repeat the wireless signal;
a beam steering to be applied to repeat the wireless signal;
a directional and distance constraints for beam forming, e.g as black or white list
beam tapering (refinement), e.g. for sidelobe suppression
recovery beam candidates, e.g. in case of blockage or link failure
a beam sweep procedure
a beam pairing procedure
a beam set generation and identification with or without reference symbols (RS)
a timing or delay to be applied for forwarding the wireless signal;
a resource selection to be applied to repeat the wireless signal
a confirmation of executed commands responsive to the control information

According to an embodiment, the apparatus is configured for authenticating to the wireless communication network.

According to an embodiment, the apparatus comprises a mobile termination, MT, and is configured for performing an authentication procedure with the wireless communication network.

According to an embodiment, the apparatus is configured for authenticating to the wireless communication network based on joining the wireless communication network.

According to an embodiment, the apparatus is configured for executing a limited receive signal processing of a received signal, e.g., the wireless signal, to obtain the communication mode, e.g., a TDD mode and/or FDD mode, e.g., a Type 1 repeater.

According to an embodiment, the apparatus is configured for using a specific reference signal, to identify itself or a path component provided by the apparatus.

According to an embodiment, relating, for example, to a Type 2A repeater, the control information a) indicates a specific signal/sequence to be applied in at least one of a slot, a symbol, and a duplex pattern used when forwarding the received in the wireless communication network; or b) provide power control commands or beamforming commands to reconfigure the apparatus for a change to be applied in a transmitted signal structure when compared to a structure of the signal to be forwarded and/or to reconfigure the apparatus for a change in a transmission and/or reception behaviour, e.g. how to amplify as a power control and forward, e.g., as a delay, beam, filtering, frequency control.

According to an embodiment, the apparatus is configured for executing an extended receive signal processing, e.g. in DL (network controlled) and/or UL (UE controlled) of the signal to obtain the communication mode.

According to an embodiment, the apparatus is configured, for at least one of:
mute a transmission of reference signals during specific time-slots/symbols on the access link
change a time pattern of reference signal, e.g., on the downlink, DL
decode a transmit power control command and subsequently change the power on a link towards a UE
perform beam switching, between e.g. preconfigured beams

According to an embodiment, relating, for example, to a Type 2B repeater, the apparatus is configured for executing transmit signal processing to provide repeater-specific signals towards apparatus such as UEs and gNBs, e.g., to allow the apparatus to identify itself to the wireless communication network or an apparatus such as a UE using a repeater specific ID/reference signal.

According to an embodiment, the apparatus is configured, for at least one of:
mute a transmission of reference signals during specific time-slots/symbols on the access link
change a time pattern of reference signal, e.g., on the downlink, DL
decode a transmit power control command and subsequently change the power on a link towards a UE
perform beam switching, between e.g. preconfigured beams
perform more extensive decoding—e.g. of all DCI formats, including those that may be introduced for repeaters only
decode more extensive RRC signalling, including various System Information Broadcast messages, including repeater-specific system information and dedicated RRC signalling that may be introduced for repeaters only
decode MAC CE for (modified) timing advance for the repeater,
decode MAC CE for beam indication or activation/deactivation of specific reference signals such as CSI-RS/CSI-IM on the access link
decode beam indication for the access link indicated via RRC, DCI, MAC CE or operation and maintenance messages
encode Uplink Control Information, which can carry acknowledgments with regard to DL control information,
encode MAC CE messages, which can carry acknowledgments with regard to DL commands
encode RRC messages (e.g.RRCReconfigurationComplete, Repeater-CapabilityInformation etc.).
perform adaptive beamforming on the access link, assisted by the gNB
based on the control information.

According to an embodiment, the apparatus is a first apparatus and is configured for establishing a control channel with a second apparatus, e.g., a base station or UE to receive the control signal from the second apparatus and/or to transmit a second control signal, e.g., as a response to the instructing device to the second apparatus.

According to an embodiment, the apparatus is configured for communicating in the control channel in-band or out-of-band, e.g., using NR, LTE or other Over-the-Air technology.

According to an embodiment, the apparatus is configured for using the control channel controlling actions of the apparatus for at least one access link and/or for using the control channel for an exchange of control information.

According to an embodiment, the control information includes at least one of a power control for a transmitted signal, and a beam management; a radio resource control, RRC, a medium access control, MAC, a downlink control information, DCI, an uplink control information, UCI, and an operation and maintenance, O&M, message.

According to an embodiment, the apparatus is able to support mobility of the at least one UE and/or at least one base station and/or the apparatus itself that is adapted for establishing communication with at least one UE with a first link and for establishing communication with at least one base station with a second link. Such an apparatus may be, for example, at least a part of a drone, a vehicle mounted SR or fixed SR tracking mobile UEs.

According to an embodiment, the apparatus is configured for establishing or maintaining the communication with the at least one UE and/or at least one base station tracking relative spatial or directional relationship between the apparatus with at least one of the UE and the base station; and
for switching to a stationary spatial communication mode or non-flight mode on at least one of the first and second link when mobility on at least one of the first link and the second link is below a threshold to further amplifying and forwarding signals between the at least one base station and the at least one UE in downlink and/or uplink.

According to an embodiment, the apparatus is a first apparatus and is configured for repeating a signal to be repeated of a second apparatus, wherein the first apparatus is configured for determining, based on an instruction determined from the control signal a timing advance of the first apparatus for communication with a base station and for repeating the signal to be repeated towards the base station based on the timing advance.

According to an embodiment, the apparatus is configured for deriving an instruction from the control signal, the instruction indicating a delay to be implemented when forwarding a signal; and to operate accordingly.

According to an embodiment, the apparatus is configured for implementing the delay by use a corresponding delay line or by digitising, storing, reading and forwarding the signal.

According to an embodiment, the apparatus is configured for inserting a transmitter-specific information into a predetermined resource, e.g., a time and/or frequency and/or spatial resource of, e.g., a CORESET of a frame or beam used for the wireless communication responsive to receiving corresponding instructions received from the wireless communication network.

According to an embodiment, the apparatus is configured for inserting the transmitter-specific information as an identifier that tags a signal path component, e.g., a multipath component created by the apparatus, a location or to tag the apparatus.

According to an embodiment, the apparatus-specific information is specific for a group of apparatus or for an individual apparatus.

Embodiments in accordance with the present disclosure relate to an apparatus such as but not limited to a coordinator node for a wireless communication network.

According to an embodiment, a coordinator node comprises a control unit configured for deriving instructions for a plurality of repeater devices so as to commonly control communication and/or operation of the plurality of repeaters; and to directly or indirectly control the plurality of repeaters.

According to an embodiment, the control unit is configured for controlling the plurality of repeater devices to mitigate an overall interference caused by the plurality of repeaters.

According to an embodiment, at least one of the plurality of repeater devices is a repeater in accordance with the present disclosure.

According to an embodiment, the coordinator node is configured for controlling a set of apparatus to implement a controllable delay individually for each of the set of apparatus to timely align communication of the set of apparatus.

Embodiments in accordance with the present disclosure relate to an apparatus such as but not limited to a wireless communication network.

According to an embodiment a wireless communication network comprises:
at least one UE-apparatus as described herein as a first apparatus;
at least one base station apparatus as described herein as a second apparatus; and
at least one repeater-apparatus as described herein as a third apparatus;
wherein the third apparatus is configured for amplifying and forwarding a first signal received from the first apparatus to the second apparatus to repeat the first signal and/or for amplifying and forwarding a second signal received from the second apparatus to the first apparatus to repeat the second signal.

According to an embodiment, the third apparatus is configured for determining spatial degrees of freedom, e.g., by its backhaul or access side capabilities/antenna numbers.

According to an embodiment, the third apparatus is configured for providing a same or reduced channel rank compared to a direct channel between the first apparatus and the second apparatus, but at a higher signal power level, e.g., in one case, the system/link SNR is very high while the rank is still low e.g. ONE which is not to be expected in a direct link between BTS and UE.

According to an embodiment, the second apparatus is configured for controlling a set of apparatus including the second apparatus to implement a controllable delay individually for each of the set of apparatus to timely align communication of the set of apparatus.

Embodiments in accordance with the present disclosure relate to methods.

According to an embodiment, a method for operating a first apparatus, comprises:
determining information indicating that a communication to a second apparatus within the wireless communication network is based on a third apparatus repeating a signal transmitted to the first apparatus or from the first apparatus to obtain a determination result; and
transmitting a signal containing information indicating that the determination result; and/or adapting the communication based on the determination result.

According to an embodiment, a method for operating a second apparatus:
determining, that communication within a wireless communication network and with a second apparatus comprises repeating of a signal by a third apparatus to obtain a determination result; and adapting the communication in the wireless communication network based on the determination result; and/or
transmitting a signal, to the second apparatus, using a channel inside or outside the wireless communication network, the signal indicating instructions requesting the second apparatus to perform measurements in the wireless communication network to obtain a measurement result, the measurement result indicating whether the communication to the second apparatus comprises repeating of a signal by a third apparatus.

According to an embodiment, a method for operating a second apparatus comprises:
transmitting a signal to a third apparatus, the signal indicating instructions regarding a Duplex pattern used in the wireless communication network and/or slot format indication requesting the third apparatus to perform changes in at least one of a slot, a symbol and a Duplex pattern when repeating a signal; and/or
transmitting a signal to the third apparatus, the signal indicating a specific signal/sequence to instruct the third apparatus a) to perform changes in at least one of a slot, a symbol, and a Duplex pattern used in the wireless communication network; or b) provide power control commands or beamforming commands to reconfigure the third apparatus; and/or
transmitting a signal to the third apparatus, the signal indicating a specific signal/sequence to instruct the third apparatus to a) perform changes in at least one of a slot, symbol, and a Duplex pattern or b) to provide power control commands or beamforming commands; and/or c) to instruct transmit/insert/replace a specific message/signal into the repeated signal, e.g., a forwarded stream in which a type 2B repeater may insert signals; and/or
transmitting a signal to the third apparatus, the signal indicating a specific signal/sequence to instruct the third apparatus, a) to perform changes in at least one of a slot, a symbol, a Duplex pattern or b) power control commands or beamforming commands; and/or c) to transmit a specific message to the apparatus.

According to an embodiment, a method for operating a first apparatus a method for operating an apparatus, e.g., a repeater, comprises:
receiving a wireless signal;
obtaining, from the wireless communication network, control information indicating at least one of an information about an ON/OFF mode; and information about a communication mode; and
operating according to the obtained control information for repeating the wireless signal.

A method described herein may be transferred to a computer readable digital storage medium having stored thereon a computer program having a program code for performing, when running on a computer, such a method.

In the specification reference is made to a coordinator node, an apparatus or a set of apparatus for performing a described function. For implementing such a function, the apparatus may comprise hardware components and optionally software components. For example, to transmit and/or receive a wireless signal, an apparatus may comprise an antenna arrangement having at least one antenna. A plurality of antennas may be used to allow for beamforming functionality. For decoding and/or evaluating a signal, for determining or processing information the apparatus may comprise a processing unit such as a processor, a microcontroller, a Field Programmable Gate Array, FPGA, a Central Processing Unit, CPU, a Graphical Processing Unit, GPU or the like to perform the described operations which may include to execute a piece of software. For storing information, the apparatus may comprise or may wirelessly or wiredly access a data memory. For amplifying a signal, an apparatus described herein may comprise an amplifier entity or the like.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

References

| Reference Label | Details |
|---|---|
| RP-202748 | Qualcomm, RP-202748, Summary of email discussions on NR Repeaters, |
| | 3GPP TSG-RAN Meeting #90e, Electronic Meeting, Dec. 7-11, 2020 |
| RP-210818 | Qualcomm, RP-210818, New WID on NR Repeaters, 3GPP TSG RAN |
| | Meeting #91e, Electronic Meeting, Mar. 16-26, 2021 |
| RP-210750 | Status Report to TSG, RP-210750, 3GPP TSG RAN meeting #91e, Electronic |
| | Meeting, Mar. 16-26, 2021 |
| R4-2101156 | Mediatek, R4-2101156, TSG-RAN WG4 Meeting #98-e, |
| | Electronic Meeting, Jan. 25-Feb. 5, 2021 |
| TS38212 | 3GPP TS 38.212 V16.5.0 (2021-03) |
| Dahlman et al | “5G NR: The next generation Wireless Access Technology”, Eric Dahlman, |
| | Stefan Parkvall and Johan Skold. |
| Zaidi et al | “5G Physical Layer Principles, Models and Technology Components” |
| Sharetecnote | https://www.sharetechnote.com/html/5G/5G_CSI_RS_Codebook.html |
| Yong | 3GPP Workshop: 3GPP 5G Technology and Self Evaluation Results |
| Bullets | 5G in Bullets, |
| | http://www.5g-bullets.com/5G%20in%20Bullets%20-%20PMI_Sample.pdf |
| Lei et al | “5G System Design: An End to End Perspective”, Wan Lei, Anthony C. K. |
| | Soong, Liu Jianghua, Wu Yong, Brian Classon, Weimin Xiao, David |
| | Mazzarese, Zhao Yang and Tony Saboorian, Springer 2020, ISBN 978-3-030- |
| | 22235-2, ISBN 978-3-030-22236-9 (eBook), |
| | https://doi.org/10.1007/978-3-030-22236-9 |
| [Onggosanusi et al] | “Modular and High-Resolution Channel State Information and Beam |
| | Management for 5G New Radio,” E. Onggosanusi et al., in IEEE |
| | Communications Magazine, vol. 56, no. 3, pp. 48-55, March 2018 |

Abbreviations

| | | Further |
|---|---|---|
| Abbreviation | Definition | description |
| 2G | second generation | |
| 3G | third generation | |
| 3GPP | third generation partnership project | |
| 4G | fourth generation | |
| 5G | fifth generation | |
| 5GC | 5G core network | |
| ACLR | adjacent channel leakage ratio | |
| AGC | automatic gain control | |
| AP | access point | |
| ARQ | automatic repeat request | |
| BER | bit-error rate | |
| BLER | block-error rate | |
| BH | backhaul | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CP1 | control plane 1 | |
| CP2 | control plane 2 | |
| CSI-RS | channel state information reference | |
| CU | central unit | |
| D2D | device-to-device | |
| DAPS | dual active protocol stack | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DU | distributed unit | |
| ECGI | E-UTRAN cell global identifier | |
| E-CID | enhanced cell ID | |
| eNB | evolved node b | |
| EN-DC | E-UTRAN-New Radio dual connectivity | |
| EUTRA | Enhanced UTRA | |
| E-UTRAN | Enhanced UTRA network | |
| gNB | next generation node-b | |
| GNSS | global navigation satellite system | |
| GPS | global positioning system | |
| HARQ | hybrid ARQ | |
| IAB | integrated access and backhaul | |
| ID | identity/identification | |
| HIOT | industrial Internet of things | |
| IM | interference management | |
| KPI | key-performance indicator | |
| LTE | Long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MT | mobile termination | |
| MR-DC | multi-RAT dual connectivity | |
| NCGI | new radio cell global identifier | |
| NG | next generation | |
| ng-eNB | next generation eNB | node providing |
| | | E-UTRA |
| NG-RAN | either a gNB or an ng-eNB | |
| NR | new radio | |
| NR-U | NR unlicensed | NR operating |
| | | in unlicensed |
| OAM | operation and maintenance | |
| OEM | OEM original equipment manufacturer | |
| OTT | OTT over-the-top | |
| PCI | physical cell identifier | Also known |
| | | as PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network information | |
| RIM-RS | RIM reference signal | |
| RLC | radio link control | |
| RLF | radio link failure | |
| RLM | radio link monitoring | |
| RNTI | radio network temporary identifier | |
| RP | reception point | |
| R-PLMN | registered public land mobile network | |
| RRC | radio resource control | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| SA | standalone | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SMR | smart mobile repeater | |
| SNR | signal-to-noise ratio | |
| SON | self-organising network | |
| SOTA | state-of-the-art | |
| SR | smart repeater | |
| SRS | sounding reference signal | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TDD | time division duplex | |
| TSG | technical specification group | |
| UE | user equipment | |
| UL | uplink | |
| URLLC | ultra-reliable low latency communication | |
| UTRAN | universal trunked radio access network | |
| V2X | vehicle-to-everything | |
| VoIP | voice over Internet protocol | |
| WI | work item | |
| WLAN | wireless local area network | |

1. An apparatus, e.g., a User Equipment, UE, configured for communicating in a wireless communication network, wherein the apparatus is a first apparatus and is configured for:
determining, to acquire a determination result, information indicating that a communication to a second apparatus within the wireless communication network is based on a third apparatus repeating a signal transmitted to the first apparatus or from the first apparatus; and
transmitting a signal comprising information indicating the determination result; and/or
adapting the communication based on the determination result.

2. The apparatus of claim 1, wherein the apparatus is adapted for acquiring information that repeating the signal relates to a channel rank of the communication to determine the determination result; and for adapting the communication based on the channel rank.

3. The apparatus of claim 1, wherein the apparatus is adapted for acquiring information that repeating the signal relates to a direction, e.g., of a signal path, of the communication to determine at least a part of the determination result;
and for adapting the communication based on the determined direction.

4. The apparatus of claim 1, wherein the apparatus is adapted for
acquiring information that repeating the signal relates to a delay, e.g., along a signal path, of the communication to determine at least a part of the determination result; and for
adapting the communication based on the determined delay.

5. The apparatus of claim 1, wherein the apparatus is adapted for
acquiring information that repeating the signal relates to a specific signal component property of the communication to determine at least a part of the determination result; and for
adapting the communication based on the determined specific signal component property, wherein the specific signal component property is at least one of:
a rank of the channel
a spatial signal path component(s) aka direction
a delay of signal path component (s)
a power of signal path component (s)
a time frequency resource.

6. The apparatus according to claim 1, wherein the apparatus is configured for acquiring location-related information from another network entity to determine the information indicating that the communication to the second apparatus is based on the third apparatus, the location-related information indicating at least one of the an angular direction of a reference signal, a position of the second or the third apparatus, a position of the apparatus itself.

7. The apparatus according to claim 1, wherein the apparatus is configured for acquiring context information from another network entity to determine at least a part of the determination result, the context information indicating at least one of an operational mode of the third apparatus and options of the third apparatus relating to at least one of the first apparatus and the second apparatus.

8. The apparatus according to claim 1, wherein the apparatus is configured for acquiring capability information from another network entity to determine at least a part of the determination result, the capability information indicating at least one operational mode of the third apparatus, that is controllable by at least one of the first apparatus and the second apparatus.

9. The apparatus of claim 1, wherein the apparatus is configured for
transmitting a first signal directly to the second apparatus together with transmitting the first or a second signal directly to the third apparatus, to cause the third apparatus for forwarding to the second apparatus; and/or
receiving a third signal directly from the second apparatus together with receiving a fourth signal directly from the third apparatus, the fourth signal being forwarded to the first apparatus by the third apparatus.

10. The apparatus of claim 1, wherein the apparatus is configured for identifying a path component of a multipath environment the wireless communication based on a received transmitter-specific information received at a predetermined resource, e.g., a time and/or frequency resource of, e.g., a CORESET of a frame of the wireless communication network with a signal received from the transmitter.

11. The apparatus of claim 10, wherein the apparatus is configured for identifying the path component by determining of a metric, e.g. a power ration between a direct path (gNB to UE) and an indirect path (gNB to SR/SR to UE).

12. The apparatus of claim 11, wherein the apparatus is configured for reporting the metric to the wireless communication network.

13. The apparatus of claim 10, wherein the apparatus is configured for reporting at least a subset of identified path components, a parameter or value derived thereof and/or an action determined from an identified path component to the wireless communication.

14. An apparatus, e.g., a repeater, configured for communicating in a wireless communication network, wherein the apparatus is configured for
receiving a wireless signal;
acquiring, from the wireless communication network, control information indicating at least one of an information about an ON/OFF mode; and information about a communication mode; and
operating according to the acquired control information for repeating the wireless signal.

15. The apparatus of claim 14, wherein the apparatus is configured for acquiring the control information from the wireless signal; and/or for receiving a control signal comprising the control information.

16. The apparatus of claim 14, being configured for authenticating to the wireless communication network.

17. The apparatus of claim 16, wherein the apparatus comprises a mobile termination, MT, and is configured for performing an authentication procedure with the wireless communication network.

18. The apparatus of claim 14, wherein the apparatus is configured for executing a limited receive signal processing of a received signal, e.g., the wireless signal, to acquire the communication mode, e.g., a TDD mode and/or FDD mode.

19. The apparatus of claim 18, wherein the apparatus is configured for using a specific reference signal, to identify itself or a path component provided by the apparatus.

20. The apparatus of claim 14; wherein the control information indicates a specific signal/sequence to be applied in at least one of a slot, a symbol, and a duplex pattern used when forwarding the received in the wireless communication network; or b) provide power control commands or beamforming commands to reconfigure the apparatus for a change to be applied in a transmitted signal structure when compared to a structure of the signal to be forwarded and/or to reconfigure the apparatus for a change in a transmission and/or reception behaviour.

21. The apparatus of claim 14, wherein the apparatus is configured for executing an extended receive signal processing, e.g. in DL (network controlled) and/or UL (UE controlled) of the signal to acquire the communication mode.

22. The apparatus of claim 14, wherein the apparatus is configured for executing transmit signal processing to provide repeater-specific signals towards apparatus such as UEs and gNBs, e.g., to allow the apparatus to identify itself to the wireless communication network or an apparatus such as a UE using a repeater specific ID/reference signal.

23. The apparatus of claim 14, wherein the apparatus is a first apparatus and is configured for establishing a control channel with a second apparatus to receive a control signal from the second apparatus and/or to transmit a control signal to the second apparatus.

24. The apparatus of claim 23, wherein the apparatus is configured for using the control channel controlling actions of the apparatus for at least one access link and/or for using the control channel for an exchange of control information.

25. The apparatus of claim 24, wherein the control information comprises at least one of a power control for a transmitted signal, and a beam management; a radio resource control, RRC, a medium access control, MAC, a downlink control information, DCI, an uplink control information, UCI, and an operation and maintenance, O&M, message.

26. The apparatus of claim 14, being able to support mobility of the at least one UE and/or at least one base station and/or the apparatus itself, e.g., a drone, that is adapted for establishing communication with at least one UE with a first link and for establishing communication with at least one base station with a second link.

27. The apparatus of claim 26, wherein the apparatus is configured for establishing or maintaining the communication with the at least one UE and/or at least one base station tracking relative spatial or directional relationship between the apparatus with at least one of the UE and the base station; and
for switching to a stationary spatial communication mode or non-flight mode on at least one of the first and second link when mobility on at least one of the first link and the second link is below a threshold to further amplifying and forwarding signals between the at least one base station and the at least one UE in downlink and/or uplink.

28. The apparatus of claim 14, wherein the apparatus is a first apparatus and is configured for repeating a signal to be repeated of a second apparatus, wherein the first apparatus is configured for determining, based on an instruction determined from the control information a timing advance of the first apparatus for communication with a base station and for repeating the signal to be repeated towards the base station based on the timing advance.

29. The apparatus of claim 14, wherein the apparatus is configured for deriving an instruction from the control information, the instruction indicating a delay to be implemented when forwarding a signal; and to operate accordingly.

30. The apparatus of claim 29, wherein the apparatus is configured for implementing the delay by use a corresponding delay line or by digitising, storing, reading and forwarding the signal.

31. The apparatus of claim 14, wherein the apparatus is configured for inserting a transmitter-specific information into a predetermined resource, e.g., a time and/or frequency and/or spatial resource of, e.g., a CORESET of a frame or beam used for the wireless communication responsive to receiving corresponding instructions received from the wireless communication network.

32. The apparatus of claim 31, wherein the apparatus is configured for inserting the transmitter-specific information as an identifier that tags a signal path component, e.g., a multipath component created by the apparatus, a location or to tag the apparatus.

33. The apparatus of claim 31, wherein the apparatus-specific information is specific for a group of apparatus or for an individual apparatus.

34. A wireless communication network comprising:
at least one apparatus according to claim 1 as a first apparatus;
at least one base station as a second apparatus; and
at least one apparatus, e.g., a repeater, configured for communicating in a wireless communication network, wherein the apparatus is configured for
receiving a wireless signal;
acquiring, from the wireless communication network, control information indicating at least one of an information about an ON/OFF mode; and information about a communication mode; and
operating according to the acquired control information for repeating the wireless signal, as a third apparatus;
wherein the third apparatus is configured for amplifying and forwarding a first signal received from the first apparatus to the second apparatus to repeat the first signal and/or for amplifying and forwarding a second signal received from the second apparatus to the first apparatus to repeat the second signal.

35. The wireless communication network of claim 34, wherein the third apparatus is configured for determining spatial degrees of freedom, e.g., by its backhaul or access side capabilities/antenna numbers.

36. The wireless communication network of claim 34, wherein the third apparatus is configured for providing a same or reduced channel rank compared to a direct channel between the first apparatus and the second apparatus, but at a higher signal power level, e.g., in one case, the system/link SNR is very high while the rank is still low e.g. ONE which is not to be expected in a direct link between BTS and UE.
